(19) United States
(12) Patent Application Publication
(10) Pub. No.: US 2009/0201149 A1
(43) Pub. Date: Aug. 13, 2009

(54) MOBILITY TRACKING METHOD AND USER LOCATION TRACKING DEVICE

(76) Inventor: Mitsuru KAJI, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/344,845

(22) Filed: Dec. 29, 2008

(30) Foreign Application Priority Data
Dec. 26, 2007 (JP) 2007-335397

(51) Int. Cl. G08B 1/08

(52) U.S. Cl. 340/539.13

(57) ABSTRACT

A user location tracking method allows a topology of a travel path taken by a user to be estimated without the use of location information such as GPS coordinates, so that a travel range of the user who only carries a small-sized terminal can be tracked at all times. The mobility tracking method is employed by a user location tracking device which uses radio waves sent from wireless devices distributed ubiquitously, the mobility tracking method including: detecting wireless device information identifying wireless devices out of the ubiquitously available wireless devices when the radio waves are received at a location where the user location tracking device is situated; storing the detected wireless device information as historical data; and estimating a topology, as the user location tracking device is moving, that shows a positional relation and a connection relation of a travel path taken by the user location tracking device, the estimation being performed on the basis that the location of the user location tracking device has deviated from a previously tracked path which has been traveled before by the user location tracking device and that the location of the user location tracking device has returned to the previously tracked path, using the stored historical data.

### BACKGROUND OF THE INVENTION

(1) Field of the Invention

The present invention relates to a mobility tracking method and a user location tracking device used for tracking where a user is using radio waves from ubiquitously available wireless devices and, more characteristically, to a mobility tracking method and a user location tracking device used for tracking a travel range of the user through location estimation carried out using an unsupervised training algorithm based on time series data.

(2) Description of the Related Art

In recent years, many crimes against small children, including elementary school students, have been occurring, which has become a social problem. For the safety of children, it is important to guide the children not to go to dangerous places. In that sense, it is said to be necessary for a parent to know where his or her child is. Also, there is a need for enhanced service, such as offers of health advice and provision of information suited to the situation, to be realized through grasping living activities of the user.

When a location or a living activity of a person is determined using a conventional technology, global positioning system (GPS) coordinates are required in order for a travel path or the like of the child user to be plotted on an existing map (see Patent Publication No. 3460400, for example). When a system employing GPS coordinates is used, there are problems, such as that a GPS terminal is too large for a small child to directly wear and that when the terminal is placed indoors or put in a bag, measurement by the GPS is difficult, meaning that the location of the user cannot be tracked at all times. Moreover, the size of power mountable in a portable terminal is limited and, for this reason, it is hard for the terminal to keep operating in terms of power consumption.

With this being the situation, the proliferation of the wireless communication technology has increased the number of wireless devices in living environments. For acquiring information regarding the location of the user without using a GPS, a method of estimating a location of a mobile terminal using wireless devices arranged in a field has been proposed. As such a method, an indoor location estimation system using access points of a wireless LAN has been studied as a pioneering research where experiments based on measurement and training are performed using a received signal strength indicator (RSSI) (see Non-patent Reference “RADAR: An In-Building RF-based User Location and Tracking System” by P. Bahl and V. N. Padmanabhan, in Proceedings of the IEEE Infocom 2000, Tel-Aviv, Israel, vol. 2, March 2000, pp. 775-784).

A method of estimating the location of the mobile terminal using the wireless devices arranged in the field is roughly divided into three, which are: the range-based localization and the fingerprinting-based localization that are both disclosed in the above-mentioned Non-patent Reference; and the proximity-based localization. Each method is explained as follows.

When the range-based localization is employed, a known location of a wireless terminal is set as a reference point so that the location of the mobile terminal is determined by measuring a relative position from the reference point. Here, the method of measuring a positional relation with respect to the reference point varies depending on the system used. In the case of the above Non-patent Reference, the location of the in-building mobile terminal is estimated using the coordinates of the access points of the in-building wireless LAN and the distance between the access points and the mobile terminal estimated from the distance attenuation characteristic of the RSSI.

When the proximity-based localization is used, known locations of wireless terminals are set as reference points as in the case of the range-based localization and a position determined by coordinates of a reference point which is estimated to be nearest to the mobile terminal based on electrical field strength or the like is determined as the location of the mobile terminal. A method, whereby a mobile terminal reads a plurality of arranged Radio Frequency Identification (RFID) tags onto each of which coordinates are written so that the location of the mobile terminal is estimated, belongs to the proximity-based localization. Although the algorithm is simplified in this case, a lot of reference points are required to ensure accuracy in estimating the location as compared with the case of the range-based localization.

When the fingerprinting-based localization is used, a relation between a pre-measured location and a radio wave environment is recorded or learned as training data for each position of areas which are to be objects of the location estimation. Then, the radio wave environment measured by the mobile terminal is verified against the training data, so that the location of the mobile terminal is estimated. It should be noted that information used as the radio wave environment and the methods of holding and verifying the training data depend on a system used. As the fingerprinting-based localization in the above-mentioned Non-patent Reference, the following are compared: the method whereby the radio field intensity of the mobile terminal is measured at a plurality of access points of the wireless LAN and the location at which the training data has the closest pattern of the radio wave intensity is selected; and the method whereby a plurality of candidates are selected and the weighted average is calculated. For example, Patent Publication No. 3165391 discloses that a relation between a location and a radio wave environment is learned according to the neural network method so that a more detailed location than the measured location is estimated through interpolation effect which is one of characteristics of the neural network. Moreover, Japanese Unexamined Patent Application Publications No. 2005-532560 and No. 2005-24540, for example, disclose that the radio wave intensity distribution of the measured locations of the training data is learned and held using probability models. Here, above Japanese Unexamined Patent Application Publication No. 2005-532560 intends to provide a more detailed location than the measured location of the training data by interpolating the radio wave intensity distribution using the layout information. Even with the interpolation, the work of measuring the training data does not become completely unnecessary. Thus, when radio waves of wireless devices ubiquitously available in the environment are used, the measurement work needs to be done all over again every time the wireless devices are moved.

### SUMMARY OF THE INVENTION

Using the conventional range-based localization described above, although radio waves from a great number of access points of wireless LANs can be received outdoors by virtue of the proliferation of wireless LANs at home, the coordinates of these access points are unknown in general and thus cannot be used as reference points for the range-based localization. Also, in a non-line-of-sight environment where an obstruction exists between a reference point and a mobile terminal or in a multipath environment, it is difficult to measure a relative location with respect to the reference point. For this reason, even when the coordinates of the access points in homes can be acquired, it is still hard to determine the location of the outdoor mobile terminal.

Moreover, in the case of the conventional proximity-based localization, the location of the reference point itself is estimated to be the location of the mobile terminal. However, the wireless devices whose coordinates are unknown cannot be used as reference points.

Furthermore, when the conventional fingerprinting-based localization is used, the coordinates of the reference points are unnecessary and the method is suitable for the non-line-of-sight environment and the multipath environment. However, the measurement locations for the training data need to be acquired through another method. Also, the accuracy in estimating the location using the fingerprinting-based localization depends on the number of pre-measured locations for the training data. More specifically, measurement needs to be performed at a lot of locations and a relation between GPS coordinates and a radio wave environment has to be learned in advance. Thus, it is difficult to employ this method outdoors in a wider region.

The present invention is conceived in view of the stated problems, and an object of the present invention is to provide a mobility tracking method and a user location tracking device which can track where the user is at all times by estimating a topology of a travel path taken by the user who only carries a small-sized terminal, without using location information such as GPS coordinates.

In order to achieve the stated object, the mobility tracking method of the present invention is a mobility tracking method used by a device which tracks a travel range of a tracking object using radio waves sent from wireless devices which are ubiquitously available, the mobility tracking method including: detecting wireless device information identifying wireless devices out of the ubiquitously available wireless devices when the radio waves are received at a location where the tracking object is situated; storing the wireless device information detected in the detecting as historical data; and estimating a topology which shows a positional relation and a connection relation of a travel path taken by the tracking object, from the historical data stored in the storing, wherein, in the estimating of the topology, the topology is estimated as the tracking object is moving, on the basis that the location of the tracking object has deviated from a previously tracked path which has been traveled before by the tracking object and that the location of the tracking object has returned to the previously tracked path.

With this, the topology of the travel path of the tracking object is estimated, based on that the tracking object has deviated from the path which has been previously tracked and that the tracking object has returned to the path which has been previously tracked. Here, when a path is taken by the user, this means the path is tracked as well and this previously taken path is referred to as the “previously tracked path” or simply as the “tracked path” hereafter. Also, the function included in such a device that tracks where the tracking object is can be embedded in a small-sized terminal. Thus, the user only has to carry the small-seized terminal which has this function, and the location of the user can be tracked at all times by estimating the topology of the travel path taken by the user, without using location information such as GPS coordinates.

Also, in order to estimate the topology of the travel path from the historical data, the estimating of the topology may include: judging whether or not a current location of the tracking object is deviating from the previously tracked path and, when it is judged that the current location of the tracking object is deviating from the previously tracked path, determining a time immediately before the deviation as a deviation time; determining a location of the tracking object on the previously tracked path at the deviation time as a deviation intersection; judging whether or not the current location of the tracking object has returned to the previously tracked path when it is judged that the current location of the tracking object is deviating from the previously tracked path and, when it is judged that the current location of the tracking object has returned to the previously tracked path, determining a time immediately after the return as a return time; determining a location of the tracking object on the previously tracked path at the return time as a return intersection; and determining a path taken by the tracking object from the deviation time to one of the return time and a current time as a newly tracked path, with a starting point of the newly tracked path being determined as the deviation intersection, and an ending point of the newly tracked path being determined as the return intersection when the return intersection has already been determined.

More specifically, assuming that a previously taken path has been already tracked, when the object deviates from the tracked path and then returns to this path later, for example, a path connecting a location at which the object deviated from the tracked path and a location at which the object returned to the path is added as the tracked path. In this way, a topology of the travel path is estimated. A period of time taken from the deviation to the return, or vice versa, may correspond to a period of time taken to move along at least one block when outdoors. Accordingly, it is recommendable that judgment as to whether a deviation or a return has occurred is made to allow for duration to be confident, in consideration of effects by environmental changes and fading.

When the judgment is made, the times when the object is judged to have deviated and have returned lag behind the times when the object actually deviated and returned. For this reason, it is desirable that the times at which the deviation and return took place are additionally estimated. Hereafter, the time of day at which the location, i.e., the user, is estimated to deviate from the tracked path is referred to as the “deviation time”. Also, the time of day at which the location, i.e., the user, is estimated to return to the tracked path is referred to as the “return time” hereafter. It should be noted that, in the estimating of the topology, since the travel path is estimated only from the historical data stored in the storing of the history, a timing at which the estimation is made is not limited to online, i.e., in real time. Note that, in the case where the processing is performed offline, the current time and the current location correspond to the time and the location of the tracking object which are judged in the judging of the deviation and the judging of the return.

Preferably, in the estimating of the topology, a triangular matrix is generated by calculating a degree of similarity, as an element of the triangular matrix, in the wireless device information stored in the storing between two detection cycles t and t′, where t′<t, t′ being a row value and t being a column value, a slope line area is extracted from the generated triangular matrix, the slope line area being formed by connecting adjacent elements whose degree of similarity exceeds a predetermined threshold value, and it is judged that the tracking object is traveling along the previously tracked path in the detection cycle t where the extracted area exists.

To be more specific, in the case where the period of time during which the tracking object is moving along the tracked path is known, the end time is the deviation time whereas the start time is the return time. Especially, when the tracking object is moving along the same path that has been taken before, an area with a high degree of similarity appears as a sloped line in the triangular matrix, so that the deviation time and the return time can be easily determined according to pattern recognition.

Moreover, it is preferable that the method of the present invention includes estimating a location of the tracking object in the detection cycle t from an arrangement of the sloped line areas in the detection cycle t of the triangular matrix, when it is judged in the estimating of the topology that the tracking object is traveling along the previously tracked path in the detection cycle t.

With this, from the arrangement of the sloped line areas in the triangular matrix, the location of the tracking object while the tracking object is moving along the tracked path can be estimated.

Furthermore, it is suitable that the degree of similarity calculated in the estimating of the topology is one of a Tanimoto coefficient and an expected value of the Tanimoto coefficient.

Here, a configuration where the tracked path is stored and the judgment as to whether a deviation or a return has occurred is made using a hidden Markov model is described. With the configuration of the present invention that employs a hidden Markov model: the previously tracked path is held as a hidden Markov model in which the location of the tracking object is a state variable and the wireless device information detected in the detecting is an observed variable; in the judging of the deviation, an observation probability is estimated for each time of day based on the historical data and the hidden Markov model of the previously tracked path obtained up to the current time, and the deviation time is determined from a degree of similarity between the estimated value of the observation probability at the time of day and the wireless device information detected at the time of day; in the determining of the deviation intersection, a maximum likelihood estimate of the state variable at the deviation time is determined as a value of the state variable at the deviation intersection, from the historical data and the hidden Markov model of the previously tracked path obtained up to the deviation time; in the judging of the return, an observation probability is estimated for each time of day in a backward direction from the current time to a past, based on the historical data and the hidden Markov model of the previously tracked path, and the return time is determined from a degree of similarity between: the estimated value of the observation probability at the time of day that is estimated in the backward direction from the current time to the past; and the wireless device information detected at the time of day; in the determining of the return intersection, a maximum likelihood estimate of the state variable at the return time is determined as a value of the state variable at the return intersection, from the historical data and the hidden Markov model of the previously tracked path obtained between the return time and the current time; and in the determining of the path: a state-label sequence of the hidden Markov model is generated as the newly tracked path; an observation probability of the newly generated state-label sequence is learned using the historical data obtained from the deviation time to one of the return time and the current time; the starting point of the newly generated state-label sequence is connected to the deviation intersection; and the ending point of the newly generated state-label sequence is connected to the return intersection when the return intersection has already been determined.

With this, the tracked path is stored and the judgment as to whether a deviation or a return has occurred is made using the hidden Markov model. Then, calculation is performed, with the location of the tracking object being a state variable and the wireless device information detected in the detecting being an observed variable. Here, the amount of calculation can be reduced when the calculation is performed using the state variable and the observed variable, as compared to the case where calculation is performed using the historical data. Accordingly, the topology of the travel path taken by the user can be estimated while the amount of calculation is reduced.

Also, when the judgment as to whether the tracking object is currently moving along the previously tracked path is made using the hidden Markov model, there is a problem generally called “over-training” where the device is adapted too much to the data acquired at the time of learning to recognize that the tracking object is moving along the previously tracked path, due to an environmental change. Especially when radio waves of IEEE802.11 access points are used, an advantage is that a lot of access points have been already set up by general users and a disadvantage is that new setups, relocations, and failures will take place constantly.

With this being the situation, the observation probability of the hidden Markov model is smoothed out by probabilities that the wireless devices are newly set up or relocated and that a failure occurs to the wireless devices.

Also, in order to avoid accumulation of environmental changes over time, the estimating of the topology may further include retraining to update the observation probability of the hidden Markov model using the historical data obtained from the return time to the deviation time.

Moreover, the estimating of the topology further include estimating the current location of the tracking object through maximum likelihood estimation using the historical data and the hidden Markov model obtained up to the current time, when the current location of the tracking object is not deviating from the previously tracked path.

With this, when the tracking object is not deviating from the tracked path, the current location of the tracking object on the tracked path can be acquired through the maximum likelihood estimation using the historical data and the hidden Markov model obtained up to the current time.

Also, by the estimating of the location, the estimating of the topology further includes recognizing, when the current location estimated in the estimating of the current location has been indicated by a same state label for a fixed number of hours during a night for a fixed period of time, a location indicated by the state label as a home of a user who owns the tracking object.

With this, when the estimated current location shows the same state label for a fixed number of hours during the night for a fixed period of time, the location indicated by this state label is recognized as home or the like of the tracking object. Similarly, as can be easily assumed, a company or a school may be recognized from the state label recognized in the daytime. These can be used as location context by a context-dependent application.

Moreover, the estimating of the topology further includes calculating a shortest period of time taken to travel between two state labels of the hidden Markov model, according to Dijkstra's algorithm.

With this, the shortest period of time taken between the two state labels of the hidden Markov model can be calculated according to Dijkstra's algorithm. When the distance is measured using such a method, it is desirable that the moving speed distribution of the state transition on the hidden Markov model be close to the moving speed distribution of a human being.

Thus, to the state-label sequence newly generated in the determining of the path, a plurality of state labels may be assigned at a same location in order for each travel direction to have one state label, and the plurality of state labels at the same location may share the observation probability. The moving speed distribution can be approximately Poisson distribution.

Furthermore, the wireless device information detected in the detecting may be a combination of identifiers included in the radio waves received in a fixed detection cycle.

In an environment where a sufficient number of wireless devices exist and an obstruction is present between parallel paths, the received radio wave shows a gradual change in a line-of-sight direction and shows a remarkable change in a non-line-of-sight direction. For this reason, the radio wave is particularly ideal as the wireless device information used in estimating the topology of the travel path. This is because poor reaction of the received wave in the width direction of the path limits the complexity of the algorithm.

Also, the ubiquitously available wireless devices may be IEEE 802.11 access points, and the radio waves received in the detecting may be beacon signals sent from the access points, and the identifiers included in the received radio waves may be IEEE 802.11 MAC addresses.

Owing to the proliferation of the IEEE 802.11 technology, the access points have been already distributed ubiquitously. These are suitable as the wireless devices for sending radio waves used in tracking the user according to the present invention.

Moreover, the mobility tracking method may further include: estimating a current location of the tracking object on the previously tracked path, through maximum likelihood estimation; storing a focused location on the previously tracked path; estimating a travel period taken from the current location to the focused location according to Dijkstra's algorithm; and notifying one of: that the current location has reached the focused location when the current location has reached the focused location; and that the travel period has fallen within a fixed period when the travel period has fallen within the fixed period.

With this, when the user revisits a specific place or comes near a specific place, the user can be notified of this. This is useful in the case where a shopping list or a personal digital assistant (PDA) is used.

Furthermore, the mobility tracking method may further include: estimating a current location of the tracking object on the previously tracked path, through maximum likelihood estimation; sending the current location of the tracking object to a separate device which tracks a travel range of a different tracking object; receiving a current location of the different tracking object from the separate device; estimating a travel period taken from the current location of the tracking object to the current location of the different tracking object according to Dijkstra's algorithm; and notifying one of: the travel period; and the travel period when the travel period has fallen within a fixed period.

With this, when a family member or a friend who owns the user location tracking device comes within a distance taking a fixed travel period of time, the distance can be notified in an actual travel period of time. It should be noted that according to the conventional technology using a GPS, a method of notifying a distance in a straight line between GPS coordinates is considered. In this case, there is a possibility that the user has to take a long way around in reality even when the notified distance is short. Here, when combined with map information, a distance measured along the road can be estimated. However, when the path has not been taken before, it may take time to move while looking at a map. Meanwhile, according to the present invention, when a child or an elderly person who owns the user location tracking device asks another user who owns another user location tracking device for help, the time actually taken for this other user to go to the place which has been visited before by the other user is notified and this is particularly useful.

Also, a user location tracking device using the mobility tracking method of the present invention is a user location tracking device for tracking a travel range of the user location tracking device using radio waves sent from wireless devices which are ubiquitously available, the user location tracking device including: a detection unit which detects wireless device information identifying wireless devices out of the ubiquitously available wireless devices when the radio waves are received; a storage unit which stores the wireless device information detected by the detection unit, as historical data; and a topology estimation unit which estimates a topology which shows a positional relation and a connection relation of a travel path taken by the user location tracking device, from the historical data stored in the storage unit, wherein the topology estimation unit estimates the topology as the user location tracking device is moving, on the basis that the location of the user location tracking device has deviated from a previously tracked path which has been traveled before by the user location tracking device and that the location of the user location tracking device has returned to the previously tracked path.

With this, based on that the user location tracking device has deviated from the tracked path and that the user location tracking device has returned to the tracked path, the topology of the travel path of the user location tracking device is estimated. Also, such a user location tracking device can be made into a small-sized terminal. Thus, without using location information such as GPS coordinates, the user location tracking device can estimate the topology of the travel path of the user and can always track the user who only carries this small-sized terminal.

Moreover, the user location tracking device may further include an identifier sending unit which regularly sends a radio wave including an identifier, wherein the identifier sending unit sends the radio wave to a separate user location tracking device only when the user location tracking device is placed on a battery charger.

Furthermore, the user location tracking device which uses the mobility tracking method of the present invention may further include a display unit which maps the topology estimated by the topology estimation unit and to display the mapped topology.

With this, it is useful that, by checking the topology of the travel path, a child or an elderly person with dementia can be tracked and the amount of exercise for health can also be grasped. In mapping, when a tracked path is held as a hidden Markov model, a method using a model of an electric charge and a spring employed generally in visualizing a graph structure can be used. To be more specific, the method, whereby the state labels whose transition probabilities are not zero are connected by a spring and the secondary arrangement is obtained so that the potential energy of a dynamic model whose repulsion is forced by the same sign of electric charge applied to the state labels is reduced to a minimum, can be used. Additionally, a method such as multi dimensional scaling (MDS) may be combined since the observation probabilities nearby show similar values. Or, an angular velocity sensor may be mounted on the user location tracking device, and then branch angles or the like at an intersection may be identified for mapping.

Also, the user location tracking device which uses the mobility tracking method of the present invention may further include: a deviation judgment unit which judges whether or not a current location of the user location tracking device is deviating from the previously tracked path; and a notification unit which, when it is judged that the current location of the user location tracking device is deviating from the previously tracked path, notifies of the deviation.

With this, when an elderly person with dementia moves away from his or her daily living area, the family can be notified about this.

Moreover, a user location tracking system of the present invention is a user location tracking system in which a travel range of a tracking object is tracked using radio waves sent from wireless devices which are ubiquitously available, the user location tracking system including: a user location tracking device which is the tracking object; and a user location tracking server, wherein the user location tracking device includes: a detection unit which detects wireless device information identifying wireless devices out of the ubiquitously available wireless devices when the radio waves are received; a storage unit which stores the wireless device information detected by the detection unit, as historical data; a history sending unit which sends the historical data to the user location tracking server; and a tracked-path receiving unit which receives a hidden Markov model from the user location tracking server, and the user location tracking server includes: a history receiving unit which receives the historical data from the user location tracking device; a path estimation unit which generates the hidden Markov model of a travel path taken by the user location tracking device, using the historical data received by the history receiving unit; and a tracked-path sending unit which sends the hidden Markov model generated by the path estimation unit to the user location tracking device.

With this, the function of the path estimation unit is included in a server device separate from the user location tracking device, and the historical data of a plurality of user location tracking devices can be sent to this server device. Accordingly, the server device can combine the received plurality of pieces of historical data to estimate the topology of the travel path of the user.

It should be noted here that the present invention may be realized not only as such a mobility tracking method and a user location tracking device, but also as: a program that causes a computer to execute steps included in the mobility tracking method; and an integrated circuit that executes the processing performed in the steps. Also, it should be obvious that such a program can be distributed via a recording medium such as a CD-ROM, or via a transmission medium such as the Internet.

Using the mobility tracking method and the user location tracking device of the present invention, the topology of the travel path of the user can be estimated and the user who only carries the small-sized terminal can be tracked at all times, without the use of location information such as GPS coordinates.

### FURTHER INFORMATION ABOUT TECHNICAL BACKGROUND TO THIS APPLICATION

The disclosure of Japanese Patent Application No. 2007-335397 filed on Dec. 26, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a configuration of a user location tracking device which realizes a mobility tracking method, according to a first embodiment of the present invention;

FIG. 2 is a diagram explaining a detection unit of the user location tracking device, according to the first embodiment;

FIG. 3 is a block diagram showing a configuration of a path estimation unit of the user location tracking device, according to the first embodiment;

FIG. 4 is a diagram showing an example of historical data stored in a history storage unit of the user location tracking device, according to the first embodiment;

FIG. 5 is a diagram showing a degree of similarity between two times of day using the Tanimoto coefficient, in the example of the historical data shown in FIG. 4;

FIG. 6 is a diagram explaining a method whereby the path estimation unit of the user location tracking device estimates a path topology, according to the first embodiment;

FIG. 7 is a diagram showing an example of the path topology estimated from what is shown in FIG. 6;

FIG. 8 is a diagram explaining o_{m, t} making up a combination of access points o (t), according to a second embodiment;

FIG. 9 is a diagram explaining o_{m, t} making up the combination of the access points o (t), according to the second embodiment;

FIG. 10 is a diagram explaining a transition probability aᵢⱼ and a probability bₙₘ, according to the second embodiment;

FIG. 11A is a diagram explaining the transition probability aᵢⱼ, according to the second embodiment;

FIG. 11B is a diagram explaining the probability bₙₘ, according to the second embodiment;

FIG. 12 is a flowchart showing processing performed by the path estimation unit which uses a hidden Markov model, according to the second embodiment;

FIG. 13 is a diagram showing an example of a judgment criterion employed by a deviation judgment unit, according to the second embodiment;

FIG. 14 is a diagram showing an example of a judgment criterion employed by a return judgment unit, according to the second embodiment;

FIG. 15 is a diagram showing an example of a method used by a path tracking unit to construct an HMM, according to the second embodiment;

FIG. 16 is a diagram showing an example of a method used by the path tracking unit to construct an HMM, according to the second embodiment;

FIG. 17 is a diagram showing an example of a method used by the path tracking unit to construct an HMM, according to the second embodiment;

FIG. 18 is a flowchart showing processing performed by the path estimation unit, according to a first modification of the second embodiment;

FIG. 19 is a flowchart showing processing performed by the path estimation unit, according to a second modification of the second embodiment;

FIG. 20 is a flowchart showing processing performed by the path estimation unit, according to a third modification of the second embodiment;

FIG. 21 is a block diagram showing a configuration of a user location tracking system, according to a third embodiment of the present invention; and

FIG. 22 is a diagram explaining the user location tracking system, according to the third embodiment of the present invention.

### DESCRIPTION OF THE PREFERRED EMBODIMENTS

### First Embodiment

The following is a description of a mobility tracking method according to the first embodiment of the present invention, with reference to the drawings.

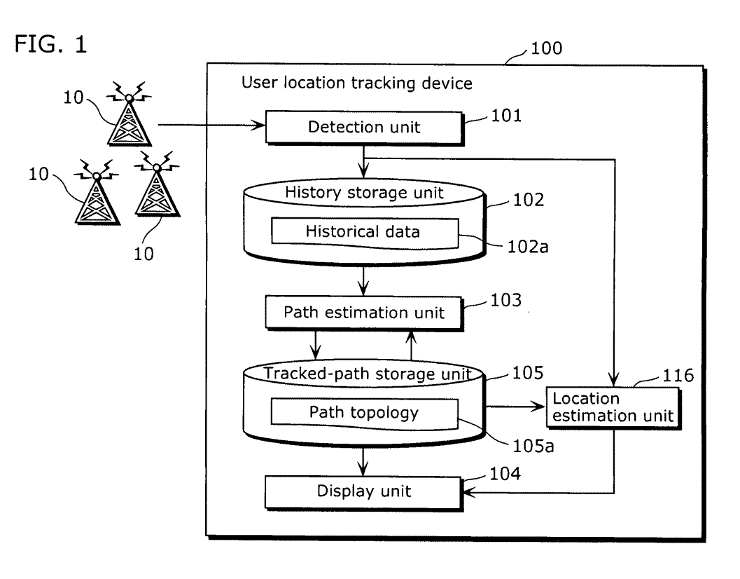

FIG. 1 is a block diagram showing a configuration of a user location tracking device 100 which realizes the mobility tracking method, according to the first embodiment of the present invention.

Using IEEE 802.11 access points which are ubiquitously available, the user location tracking device 100 tracks the location of a user who owns the user location tracking device 100. As shown in FIG. 1, the user location tracking device 100 includes a detection unit 101, a history storage unit 102, a path estimation unit 103, a tracked-path storage unit 105, a location estimation unit 116, and a display unit 104.

At a position where the user location tracking device 100, which is a tracking object, is situated, the detection unit 101 receives radio waves sent from ubiquitously available wireless devices 10 and detects which of the ubiquitously available wireless devices 10 have sent the radio waves that were received. Here, wireless device information detected by the detection unit 101 is a combination of identifiers included in the radio waves received in a fixed detection cycle.

To be more specific, the detection unit 101 receives a beacon signal which is sent by an IEEE 802.11 access point on a regular basis. The IEEE 802.11 beacon signal includes a MAC address which uniquely identifies the access point. From the received beacon signals, the detection unit 101 identifies the access points which exist nearby.

The history storage unit 102 is a memory which stores the wireless device information detected by the detection unit 101. To be more specific, the history storage unit 102 stores the access points identified by the detection unit 101 as historical data 102a for each detection cycle. This historical data 102a is stored into the history storage unit 102 by the detection unit 101. Note that the details of the historical data 102 will be described later in the present specification.

It should be noted that the detection unit 101 may detect the wireless device information without interruption for each detection cycle, detect only once for each detection cycle, or detect intermittently, like only during first few seconds. The influence of fading can be less when the detection unit 101 keeps the detection without interruption. However, in the case where the influence of fading is not a problem, the detection can be performed intermittently, thereby reducing power consumption.

The path estimation unit 103 estimates a topology of a travel path of the user location tracking device 100, which is a tracking object, from the historical data 102a stored in the history storage unit 102. To be more specific, the path estimation unit 103 estimates the topology while the user location tracking device 100 is moving, based on that the location of the user location tracking device 100 deviated from a path which the user location tracking device 100 previously traveled along, that is, the path having been tracked before, and that the location of the user location tracking device 100 returned to this path. As defined above, a path which has been previously taken by the user and thus has been already tracked is referred to as the “previously tracked path” or simply as the “tracked path”.

Moreover, the path estimation unit 103 calculates a degree of similarity in the wireless device information between two detection cycles t and t′, where t′<t, in the historical data 102a stored in the history storage unit 102, with t′being an element as a row value and t being an element as a column value. By doing so, the path estimation unit 103 generates a triangular matrix. Then, out of the elements in the generated triangular matrix, the path estimation unit 103 extracts a sloped line area which is formed by connecting adjacent elements whose degree of similarity exceeds a fixed threshold value. The path estimation unit 103 judges that the user location tracking device 100 is moving along the tracked path in the detection cycle t in which the extracted area exists. The details about the path estimation unit 103 will be described later in the present specification.

The tracked-path storage unit 105 is a memory for storing a path topology 105a which is a topology of the travel path estimated by the path estimation unit 103 to be taken by the user location tracking device 100. This path topology 105a is stored into the tracked-path storage unit 105 by the path estimation unit 103.

The location estimation unit 116 estimates the current location of the user location tracking device 100 when the user location tracking device 100 is moving along the tracked path. To be more specific, when it is judged that the user location tracking device 100 is moving along the tracked path in the detection cycle t, the location estimation unit 116 estimates the current location of the user location tracking device 100 in the detection cycle t from the arrangement of the sloped line areas in the generated triangular matrix in the detection cycle t.

The display unit 104 maps the path topology 105a estimated by the path estimation unit and displays the mapped topology. Also, the display unit 104 displays the location of the user location tracking device 100 estimated by the location estimation unit 116 on the mapped topology.

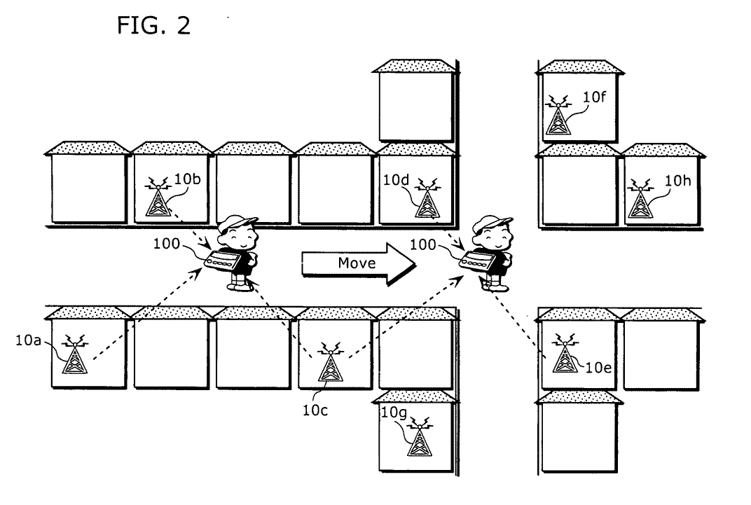

FIG. 2 is a diagram explaining the detection unit 101 of the user location tracking device 100, according to the first embodiment.

As shown in FIG. 2, at the position where the user location tracking device 100 is situated, the detection unit 101 receives the radio waves sent from the ubiquitously available wireless devices 10. In this diagram, the detection unit 101 receives the radio waves sent from the wireless devices 10a and 10b. Then, as the user location tracking device 100 moves, the detection unit 101 receives the radio waves sent from the wireless devices 10c, 10d, and 10e. That is, as combinations of the identifiers of the wireless devices 10, the detection unit 101 first receives 10a and 10b, and next receives 10c, 10d, and 10e.

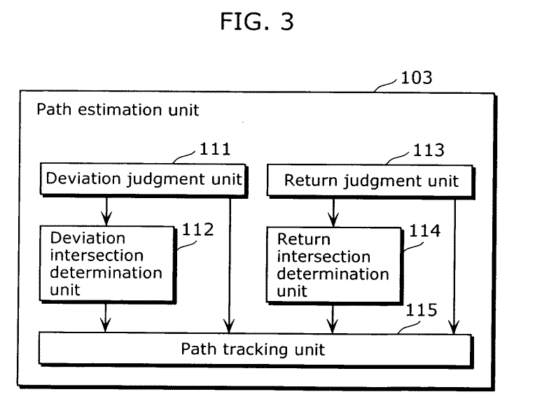

FIG. 3 is a block diagram showing a configuration of the path estimation unit 103 of the user location tracking device 100, according to the first embodiment. As shown, the path estimation unit 103 includes a deviation judgment unit 111, a deviation intersection determination unit 112, a return judgment unit 113, a return intersection determination unit 114, and a path tracking unit 115.

The deviation judgment unit 111 judges whether or not the current location of the user location tracking device 100 is deviating from the tracked path. When judging so, the deviation judgment unit 111 determines a time of day immediately before the deviation, as the time of deviation. To be more specific, the deviation judgment unit 111 determines a time of day immediately before when the detected combination of access points has little similarity to the combinations in the past detection cycles. As already defined above, the time of day at which the location is estimated to deviate from the tracked path is referred to as the “deviation time”.

When the user location tracking device 100 is judged to have deviated from the tracked path, the return judgment unit 113 judges whether or not the current location of the user location tracking device 100 has returned to the tracked path. When judging so, the return judgment unit 113 determines a time of day immediately after the return, as the time of return. To be more specific, as contrary to the way the deviation judgment unit 111 performed, the return judgment unit 113 determines a time of day immediately after when the detected combination of access points have a high degree of similarity to the ones in the past detection cycles. As already defined above, the time of day at which the location is estimated to return to the tracked path is referred to as the “return time”.

Therefore, the deviation time indicates a time of day which is immediately before the location deviates from the tracked path whereas the return time indicates a time of day which is immediately after the location returns to the tracked path. This is to say, during a period of time taken from immediately after the deviation time to immediately before the return time, the user location tracking device 100 moves along a path which has never been taken before. During the time other than this period, the user location tracking device 100 moves along the path which has been taken before, that is, the tracked path.

The deviation intersection determination unit 112 determines the position where the user location tracking device 100 is situated on the tracked path at the deviation time determined by the deviation judgment unit 111, as a deviation intersection.

The return intersection determination unit 114 determines the position where the user location tracking device 100 is situated on the tracked path at the return time determined by the return judgment unit 113, as a return intersection.

To be more specific, the deviation intersection determination unit 112 obtains the earliest time t′, for example, out of the past detection cycles in which the detected combination of access points has a close similarity to the combination of access points detected at the deviation time. Next, the deviation intersection determination unit 112 determines a path taken from the deviation time to the return time with the time t′ in between, that is, the path to which the user location tracking device 100 deviated, and estimates an approximate location on that path. Similarly, the return intersection determination unit 114 obtains the earliest time t′, for example, out of the past detection cycles in which the detected combination of access points has a close similarity to the combination of access points detected at the return time. Next, the return intersection determination unit 114 determines a path taken from the deviation time to the return time with the time t′ in between, that is, the path to which the user location tracking device 100 deviated, and estimates an approximate location on that path.

The path estimation unit 115 determines the path along which the user location tracking device 100 moves from the deviation time to the return time or the current time, as a newly tracked path. Also, the path estimation unit 115 determines a starting point of the newly tracked path as a deviation intersection and, when a return intersection is determined, determines an ending point of the newly tracked path as the return intersection. This is to say, the path estimation unit 115 generates a path whose length is proportional to a travel period of time taken to go along the path, the travel period being calculated by subtracting the deviation time from the return time. Then, the path estimation unit 115 determines the topology of the travel path by connecting the starting and ending points of the generated path respectively to the locations determined by the deviation intersection determination unit 112 and the return intersection determination unit 114. Here, when the topology is determined, this means that a positional relation and a connection relation are determined.

Next, an explanation is given in concrete terms, using examples of data.

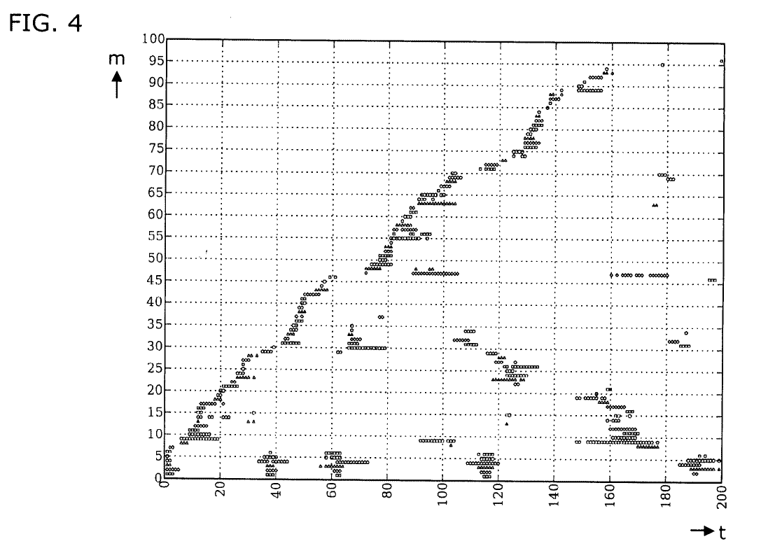

FIG. 4 is a diagram showing an example of the historical data 102a stored in the history storage unit 102 of the user location tracking device 100, according to the first embodiment. To be more specific, FIG. 4 shows an example of the historical data 102a stored in the history storage unit 102 that is obtained by the detection unit 101 which performs measurement while the user walks around a residential district.

It took a little less than 2,000 seconds for the user to walk around. The horizontal axis of this graph is indicated as t and the vertical axis is indicated as m, showing that an access point m is detected at a time t. A unit of time here is a detection cycle of 10 seconds, and the graph thus shows until t is 200. During this period of time, 96 access points are detected. The access point number m is a number assigned in order of detection of MAC addresses, for the purpose of graph display. Although the access point number is not an essential constituent element of the present invention, it is useful to save the memory capacity of the history storage unit 102 by assigning a short number to a MAC address for management. It should be noted that although the fixed time period, 10 seconds, is set as the detection cycle in this diagram, an acceleration sensor or a pedometer may be mounted on the user location tracking device 100 and a period of time during which a fixed number of steps is taken may be set as the detection cycle.

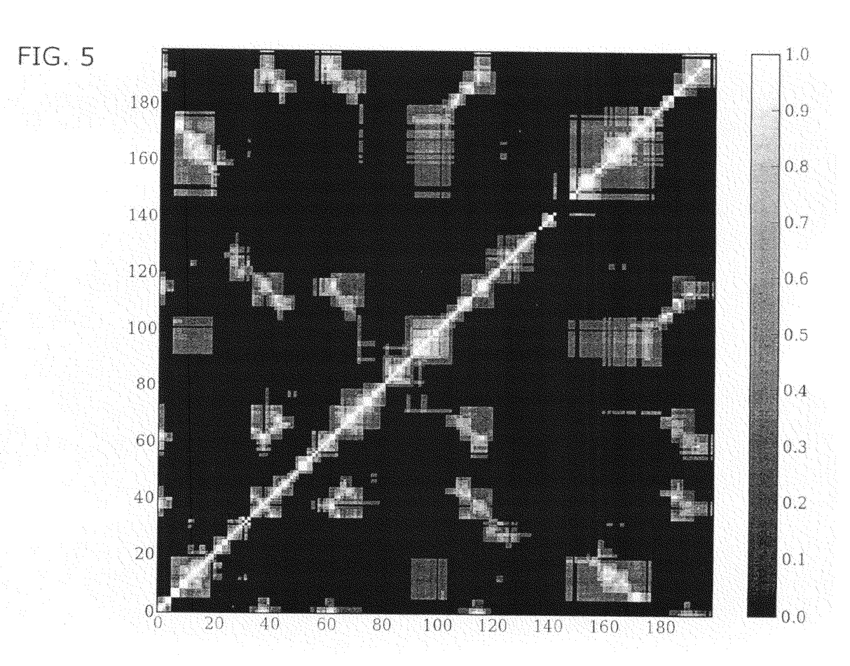

FIG. 5 is a diagram showing a degree of similarity between two times of day using the Tanimoto coefficient, in the example of the historical data shown in FIG. 4. To be more specific, this diagram shows an image representing how much the access points detected respectively at the two times in the historical data 102a shown in FIG. 4 agree with each other.

This diagram shows the Tanimoto coefficient, from 0 drawn in black to 1 drawn in white, between a set of access points detected in the detection cycle at a time of the horizontal axis and a set of access points detected in the detection cycle at a time of the vertical axis.

It should be noted that the Tanimoto coefficient between a set A and a set B is represented as: TC(A, B)=n(A∩B)/n(A∪B), where n( ) indicates the number of elements in the set. Also note that a degree of similarity between the set A and the set B is represented by a normalized value from 0 meaning a complete dissimilarity to 1 meaning a complete similarity. On the supposition that a sufficient number of access points are randomly arranged in areas in each of which reception is possible and that these reception areas are circles in the same size, the Tanimoto coefficient represents an overlap in the reception areas. Here, the degree of similarity may be calculated based on an expected value of the Tanimoto coefficient. Also, instead of the Tanimoto coefficient, a different coefficient, such as the Dice coefficient, that shows a degree of similarity between the sets may be used. Alternatively, a distance between vectors may be used.

In the diagram, light color indicates a high degree of similarity, meaning that it is highly likely that the user location tracking device 100 is situated at the same position at the times shown by the horizontal axis and the vertical axis. The deviation judgment unit 111 views this diagram in the direction of the horizontal axis, that is, the direction from left to right, and determines a time when the light-color sloped lines and the like in the lower triangle, obtained by cutting the whole graph in half on the diagonal line, are all discontinued. The return judgment unit 113 views this diagram in the direction of the horizontal axis, that is, the direction from left to right, and determines a boundary time between an area where no light parts exist and an area where light parts exist in the lower triangle of the graph. It should be noted that a light sloped line indicates that the user location tracking device 100 moves along the same path at the times corresponding to the widths of the horizontal axis and the vertical axis of the sloped line.

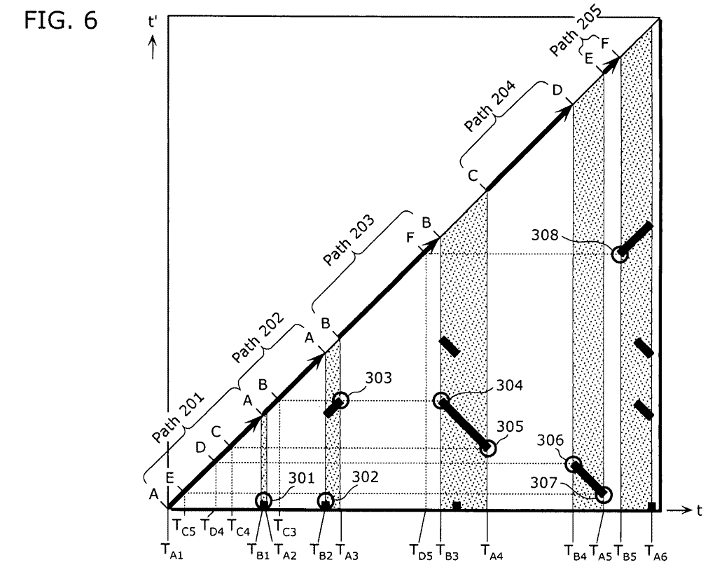

FIG. 6 is a diagram explaining a method whereby the path estimation unit 103 of the user location tracking device 100 estimates the path topology 105a, according to the first embodiment. To be more specific, this diagram shows the light sloped lines and the like extracted from the lower triangle of the graph, where t′<t, shown in FIG. 5.

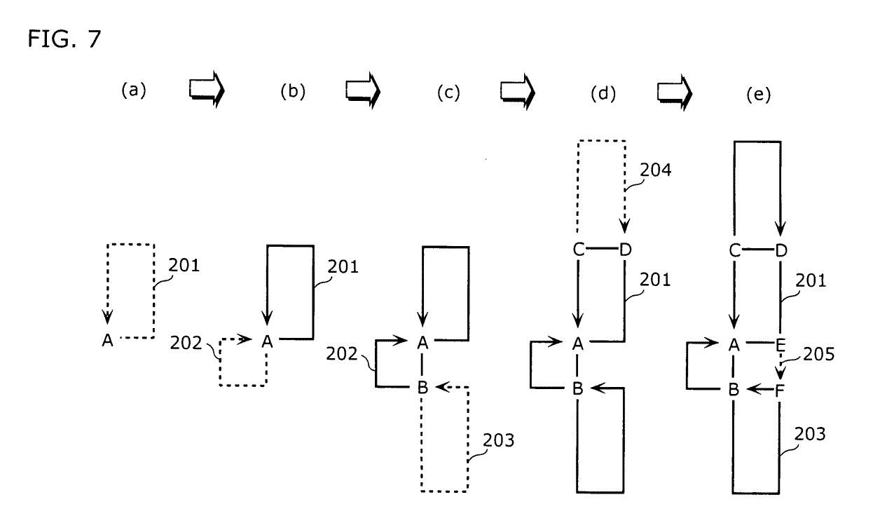

FIG. 7 is a diagram showing an example of the path topology 105a estimated from what is shown in FIG. 6.

In FIG. 6, the horizontal axis of shaded areas in which sloped lines and the like exist shows times at which the user location tracking device 100 moves along the paths that have been traveled before. The times at the far right of the shaded areas, that is, t=T_{A1}, T_{A2}, T_{A3}, T_{A4}, T_{A5} and T_{A6} are detected by the deviation judgment unit 111. Here, the starting time is also included as the deviation time. The times at the far left of the shaded areas, that is, t=T_{B1}, T_{B2}, T_{B3}, T_{B4}, and T_{B5} are detected by the return judgment unit 113. The principle of the path estimation unit 103 of the present invention is explained in chronological order, with reference to FIGS. 6 and 7.

Firstly, suppose that a path 201 is traveled from the deviation time T_{A1} to the return time T_{B1}. The return time t=T_{B1} has a high degree of similarity only to the time t′=T_{A1} at which the user location tracking device 100 starts on the path 201, as shown by 301 in FIG. 6. Therefore, the return interaction which is the ending point of the path 201 is the starting point of the path 201, meaning that the path 201 is estimated to be looped by the starting point and the ending point, as shown in FIG. 7(a). In the diagrams, the starting point of the path 201 is denoted as a point A.

Next, suppose that a path 202 is traveled from the deviation time T_{A2} immediately after the return time T_{B1} to the return time T_{B2}. The deviation time t=T_{A2} has a high degree of similarity only to the time t′=T_{A1} at which the user location tracking device 100 starts on the path 201, as shown by 301 in FIG. 6. Therefore, the deviation intersection which is the starting point of the path 202 is estimated to be the starting point of the path 201, that is, the point A. Also, the return time t=T_{B2} has a high degree of similarity to the time t′=T_{A1} which is the earliest, as shown by 302 in FIG. 6. Thus, the return intersection which is the ending point of the path 202 is also the starting point of the path 201, that is, the point A. Therefore, the path 202 is also looped by the starting point and the ending point, as shown in FIG. 7(b).

Similarly, suppose that a path 203 is traveled from the deviation time T_{A3} to the return time T_{B3}. Out of the times which have high degrees of similarity to the deviation time t=T_{A3}, the time t′=T_{C3} is the earliest, as shown by 303 in FIG. 6. Letting a section measured on the path 202 from T_{A2} to T_{C3} be one, a section from T_{C3} to T_{B2} is three. Hence, the deviation intersection which is the starting point of the path 203 is estimated to be situated approximately at one fourth of the length of the path 202. In the diagrams, this location on the path 202 is denoted as a point B. Also, out of the times which have high degrees of similarity to the return time t=T_{B3}, the time t′=T_{C3} is the earliest, as shown by 304 in FIG. 6. Thus, the return intersection which is the ending point of the path 203 is also the point B. Therefore, the path 203 is looped as well, as shown in FIG. 7(c).

Moreover, suppose that a path 204 is traveled from the deviation time T_{A4} to the return time T_{B4}. The deviation time t=T_{A4} has a high degree of similarity only to the time t′=T_{C4} as shown by 305 in FIG. 6. Letting a section measured on the path 201 from T_{A1} to T_{C4} be two, a section from T_{C4} to T_{B1} is one. Hence, the deviation intersection which is the starting point of the path 204 is estimated to be situated approximately at two thirds of the length of the path 201. In the diagrams, this location on the path 201 is denoted as a point C. Also, the return time t=T_{B4} has a high degree of similarity only to the time t′=T_{D4}, as shown by 306 in FIG. 6. Letting a section measured on the path 201 from T_{A1} to T_{D4} be one, a section from T_{D4} to T_{B1} is one. Hence, the return intersection which is the ending point of the path 204 is estimated to be situated approximately at one half of the length of the path 201, as shown in FIG. 7(d). In the diagrams, this location on the path 201 is denoted as a point D.

Furthermore, suppose that a path 205 is traveled from the deviation time T_{A5} to the return time T_{B5}. The deviation time t=T_{A5} has a high degree of similarity only to the time t′=T_{C5} as shown by 307 in FIG. 6. Letting a section measured on the path 201 from T_{A1} to T_{C5} be one, a section from T_{C5} to T_{B1} is five. Hence, the deviation intersection which is the starting point of the path 204 is estimated to be connected approximately at one sixths of the length of the path 201. In the diagrams, this location on the path 201 is denoted as a point E. Also, the return time t=T_{B5} has a high degree of similarity only to the time t′=T_{D5}, as shown by 308 in FIG. 6. Letting a section measured on the path 203 from T_{A3} to T_{D5} be five, a section from T_{D5} to T_{B3} is one. Hence, the return intersection which is the ending point of the path 205 is estimated to be connected approximately at five sixths of the length of the path 203, as shown in FIG. 7(e). In the diagrams, this location on the path 203 is denoted as a point F.

Here, the display unit 104 maps the path topology 105a estimated by the path estimation unit 103 as shown in FIG. 7, and displays the mapped topology as the travel range of the user. The displayed travel range can be used as a communication tool for the safety of children. For example, when a parent sees that a new path is added, the parent can ask his or her child as to whether the child is in an unsafe place or not. Unlike the case where GPS coordinates are used, the coordinates cannot be found on the map in real time. However, as long as the purpose is not to conduct surveillance on someone, the monitoring side can obtain an adequate amount of information while the privacy of the monitored side is protected. In the case where the user is an adult, the present invention can be used for purposes such as estimating the amount of exercise for health maintenance.

Out of the past detection cycles which include the detected combination of access points similar to the combination detected at the current time, the location estimation unit 116 obtains the earliest time t′, for example. Then, from the pair of the deviation time and the return time having the time t′ in between, the path to which the user deviated as well as an approximate location of the user on that path can be determined. For example, from the time T_{B5} to the time T_{A6} in FIG. 6, it can be seen from the arrangement of the sloped lines in FIG. 6 that the user moves from the point F to the point B then to the point A. This can show whether or not the user is going through a fixed school zone, for example. Moreover, the current location is displayed on the topology mapped by the display unit 104.

In FIG. 6, point-like areas which have a high degree of similarity are also extracted from FIG. 5 to be used for judgment. However, the judgment may be made only from the sloped lines, which are time areas during which the user moves along a path which has been traveled before for a fixed period of time or longer. A point-like area occurs when a path which has been taken before is crossed by the user, for example. However, due to the complicated radio wave propagation, it may happen that the same combination can be detected at the completely different locations. In such a case, a path which cannot have been crossed is falsely recognized as the one crossed. It should be noted that when a large number of both access points and obstructions are present in a residential district or the like, which is to say that when the contrast is high as shown in FIG. 5, the possibility of false recognition can be reduced.

### Second Embodiment

In the present embodiment, a hidden Markov model (HMM) is used by the path estimation unit 103 for pattern recognition and tracked-path holding. The Tanimoto coefficient is calculated based on the parameters of the observation probability of the hidden Markov model. On account of this, when the same path is traveled over and over again, the amount of calculation can be reduced as compared to the case where the calculation is performed among the historical data sets. It should be noted that components which are not particularly explained in the present embodiment are the same as those shown in FIG. 1.

More specifically, the tracked path is held as a hidden Markov model in which the location of the user location tracking device 100 is a state variable and the wireless device information detected by the detection unit 101 is an observed variable.

From the historical data and the hidden Markov models of the tracked paths obtained up to the current time, the deviation judgment unit 111 determines the deviation time. To be more specific, the deviation judgment unit 111 estimates the observation probability for each time of day on the basis of the historical data and the hidden Markov models of the tracked paths obtained up to the current time. Then, from a degree of similarity between the estimated value of the observation probability for each time of day and the wireless device information detected at that time of day, the deviation judgment unit 111 determines the deviation time.

From the historical data and the hidden Markov models of the tracked paths obtained up to the deviation time, the deviation intersection determination unit 112 determines the maximum likelihood estimate of the state variable at the deviation time to be the deviation intersection.

From the historical data and the hidden Markov models of the tracked paths obtained in the past up to the current time of day, i.e., in the backward direction from the current time of day to the past, the return judgment unit 113 determines the return time. To be more specific, the return judgment unit 113 estimates the observation probability for each of the times of day on the basis of the historical data and the hidden Markov models of the tracked paths obtained in the past up to the current time of day. Then, from the estimated value of the observation probability for each of the times of day in the backward direction and a degree of similarity in the wireless device information pieces detected at these times of day, the return judgment unit 113 determines the return time.

From the historical data and the hidden Markov models of the tracked paths obtained between the return time and the current time, the return intersection determination unit 114 determines the maximum likelihood estimate of the state variable at the return time to be the return intersection.

The path tracking unit 115: generates a sequence of state labels of the hidden Markov model as a newly tracked path; learns the observation probability of the newly generated state label sequence using the historical data from the deviation time to the return time or to the current time; and then connects the starting point of the newly generated state label sequence to the deviation intersection as well as connecting the ending point of the newly generated state label sequence to the return intersection if already determined.

Here, an explanation is given as to HMMs used in the present embodiment.

At a time t with the detection cycle being the unit time, where 1≦t≦T, suppose a combination of the access points detected by a mobile terminal is o (t). In the present embodiment, o (t) is treated as the observed variable of the HMM. Note that its historical data is referred to as the observed sequence. Although an IEEE 802.11 access point can be uniquely identified by a MAC address, the MAC address is inconvenient for mathematical expressions. For this reason, a number represented by m, where 1≦m≦M, is assigned to each access point as in the case shown in FIG. 4, and this number is used in place of the MAC address. Thus, o (t) can be expressed in a simple vector form as follows.

o(t)=(o_{1,t}, o_{2,t}, Λ, o_{m,t} Λ,o_{M,t}) Equation 1

Here, note that when an access point m is detected at the time t, this is expressed as o_{m, t}=1, and that when the access point m is not detected at the time t, this is expressed as o_{m, t}=0. A more detailed explanation as to o_{m, t} making up the combination of the access points o (t) is given as follows.

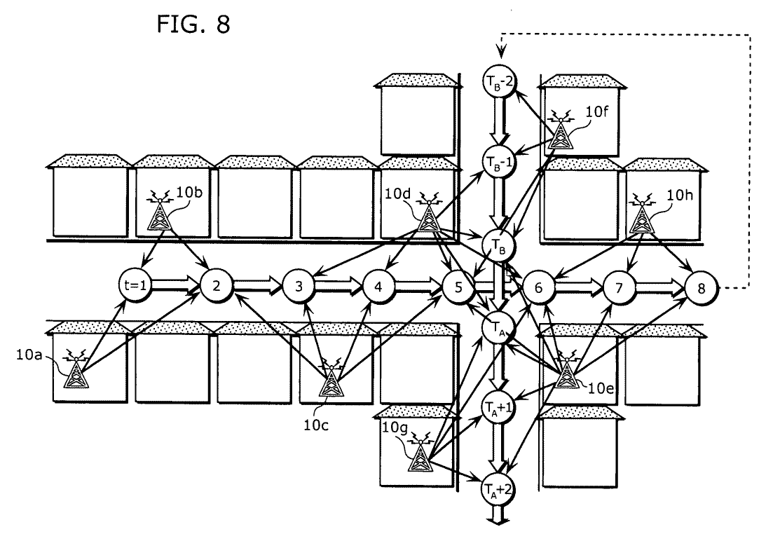

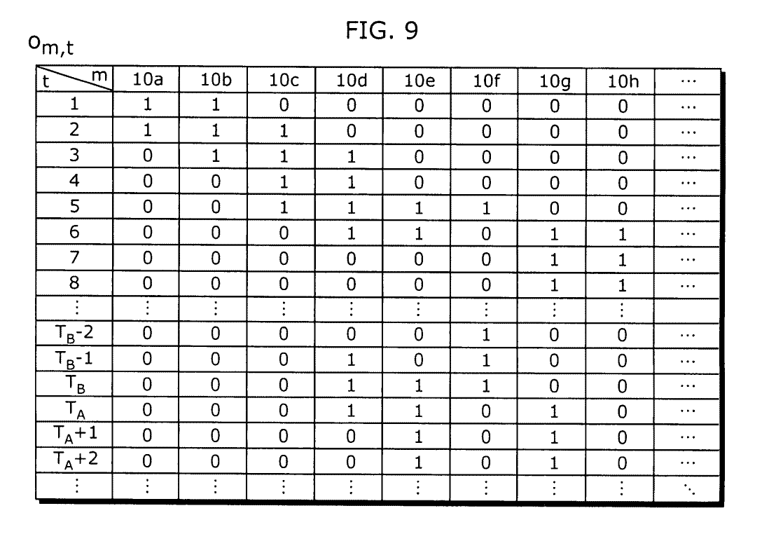

FIGS. 8 and 9 are diagrams explaining o_{m, t} making up the combination of access points o (t), according to the second embodiment.

As shown in FIG. 8, when the detection cycle t is 1, the detection unit 101 receives radio waves from the wireless devices 10a and 10b. Similarly, when the detection cycle t is 2, the detection unit 101 receives radio waves from the wireless devices 10a, 10b, and 10c. Also, when the detection cycle t is 3, the detection unit 101 receives radio waves from the wireless devices 10c and 10d. In such a way, the detection unit 101 receives radio waves from the wireless devices 10. Then, the detection unit 101 stores the detected wireless device information as the historical data 102a into the history storage unit 102.

FIG. 9 is a diagram showing an example of the historical data 102a stored in the history storage unit 102.

As shown, since the detection unit 101 receives radio waves from the wireless devices 10a and 10b when the detection cycle t is 1, the historical data is stored as o_{10a, 1}=1 representing that t=1 and m=10a, and as o_{10b, 1}=1 representing that t=1 and m=10b. Also, o_{m, t}=0 is stored regarding the other wireless devices. Similarly, since the detection unit 101 receives radio waves from the wireless devices 10a, 10b, and 10c when the detection cycle t is 2, the historical data is stored as o_{10a, 2}=1, o_{10b, 2}=1, o_{10c, 2}=1, and o_{m, t}=0 which regards the other wireless devices. In this way, the historical data is stored into the history storage unit 102 for each of the detection cycles.

The Tanimoto coefficient denoted as TC (o (t), o (t′)) which shows the combinations of access points detected at the times t and t′ can be expressed using the summation operator Σ as follows.

$$TC ( o ( t ) , o ( {t}^{′} ) ) = \frac{{\sum }_{i = 1}^{M} {o}_{i , t} {o}_{i , {t}^{′}}}{{\sum }_{i = 1}^{M} ( {o}_{i , t} + {o}_{i , {t}^{′}} ) - {\sum }_{i = 1}^{M} {o}_{i , t} {o}_{i , {t}^{′}}} \qquad Equation 2$$

It should be noted that although a fixed period of time is set as the detection cycle, namely, the time unit, an acceleration sensor or a pedometer may be mounted on the user location tracking device 100 and a period of time during which a fixed number of steps is taken may be set as the detection cycle.

Next, suppose that a location of the mobile terminal at the time t is q (t), where 1≦t≦T. Note that, in the present embodiment, q (t) is treated as a state variable, or a hidden variable, of the HMM. Also, note that, in the HMM, a value of the state variable is discretized by a state label Sₙ, where 1≦n≦N. Moreover, in the present embodiment, when a path which has never been traveled is detected, state labels corresponding, in number, to a period of time taken to travel that path are added to the model, each of the state labels being associated with a specific location on that path.

In the HMM, when it is possible to move directly from a state label Sᵢ to a state label Sⱼ, a value showing the probability is referred to as the transition probability and is expressed as follows.

aᵢⱼ=P(q(t)=Sⱼ|q(t−1)=Sᵢ) (1≦i, j≦N) Equation 3

In a Markov process, this probability does not depend on the time t. When it is not possible to move directly from the state label Sᵢ to the state label Sⱼ, this is expressed as aᵢⱼ=0. When the structure of the HMM is illustrated, a graph structure, in which the state labels whose transition probabilities are not 0 are connected, is used. In the present embodiment, a structure of the HMM is searched so that the structure is the same as the topology of the travel path.

Next, the probability of detecting o (t) in the state label Sₙ is referred to as the observation probability, and is expressed as follows.

bₙ(o(t))=P(o(t)|q(t)=Sₙ) (1≦n≦N) Equation 4

In terms of the observation probability, the probability of detecting the access point m at a location assigned with the state label Sₙ is bₙₘ. Here, the location assigned with the state label Sₙ is simply referred to as the location Sₙ hereafter. Assuming that whether an access point is detected or not is an independent event, this is given by the following equation.

$${b}_{n} ( o ( t ) ) = {\sum }_{m = 1}^{M} [ {b}_{n m} {o}_{m , t} + ( 1 - {b}_{n m} ) ( 1 - {o}_{m , t} ) ] \qquad Equation 5$$

However, in the present embodiment, smoothing is performed according to the following equation using parameters P_{A} and P_{B}, where P_{A}≦P_{B}≦1, which show the frequency of environmental changes and the like.

$${b}_{n} ( o ( t ) ) = {\sum }_{m = 1}^{M} \{ \begin{matrix}[ ( 1 - {P}_{A} ) {b}_{n m} + {P}_{A} ] \cdot {o}_{m , t} + \\ [ ( 1 - {P}_{B} ) ( 1 - {b}_{n m} ) + {P}_{B} ] \cdot ( 1 - {o}_{m , t} )\end{matrix} \} \qquad Equation 6$$

In this case here, P_{A} shows the probability that the access point which could not be received at its location at the time of training will be able to be received because of an environmental change such as relocation. Also, P_{B} shows the probability that the access point which could be received at its location at the time of training will not be able to be received because of an environmental change such as relocation or failure.

The reason why smoothing is performed is given as follows. In the present embodiment, the probability bₙₘ is learned from o (t) detected when the state label Sₙ is added to the model. However, the environments, including the arrangement of the access points, the power state of the access points, and the obstructions, change over time. Moreover, in the case where the detection unit 101 receives radio waves only in some of the detection cycles for the purpose of saving electric power, an access point which was not detected at the time of training due to influence of fading is detected next time or the reverse of this situation takes place.

In such a case, excessive compliance of bₙ (o (t)) with the data obtained at the time of training causes the possibility that the path which has been traveled before may be recognized as a path which has never been traveled. This is a problem generally called “over-training”, and P_{A} and P_{B} are parameters used in order to avoid this problem. It should be noted here that smoothing may be performed when bₙₘ is calculated instead of when the observation probability is calculated. Also note that, in the residential district, it was suitable when P_{A} was 0.05 to 0.1 and P_{B} was 0.4 to 0.5.

In this way, the observation probability of the hidden Markov model is smoothed using the probability that a wireless device 10 will be newly set up or relocated, and that a failure will occur to the wireless devices 10.

Here, a specific explanation is given as to the transition probability aᵢⱼ and the probability bₙₘ.

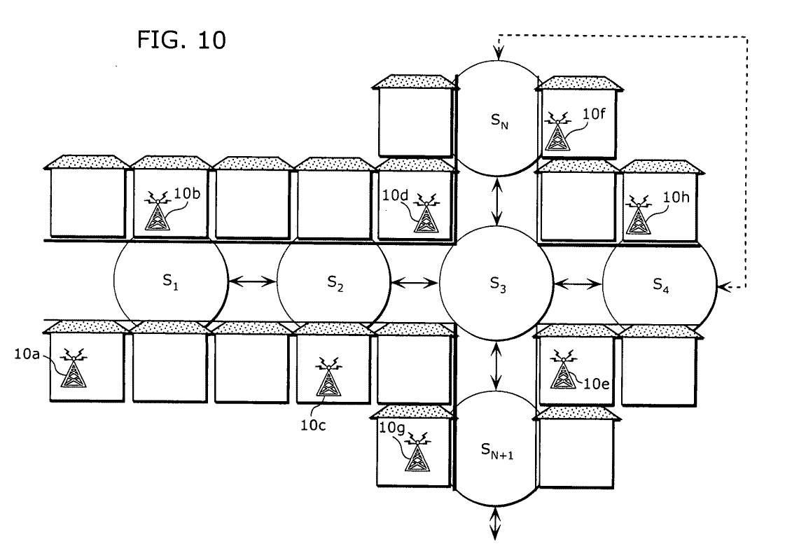

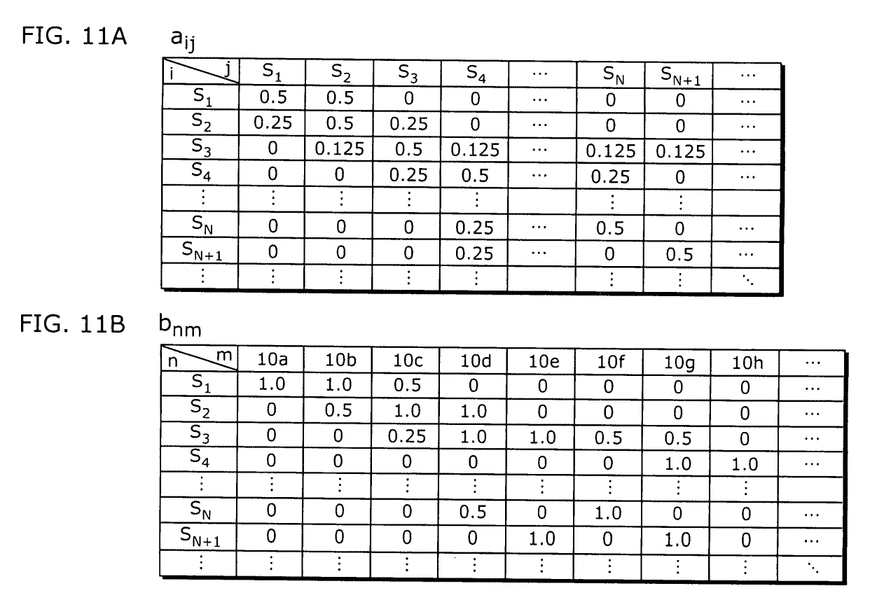

FIGS. 10, 11A, and 11B are diagrams explaining the transition probability aᵢⱼ and the probability bₙₘ, according to the second embodiment.

As shown in FIG. 10, the user location tracking device 100 makes a transition from the state label S₁ to the state label S₂, and then from the state label S₂ to the state label S₃. In this way, the user location tracking device 100 makes a transition between two state labels.

For example, the user location tracking device 100 can make a transition from the state label S₁ only to the state label S₂. On this account, when the probability that the user location tracking device 100 will stay at the state label S₁ is 0.5, the probability that the user location device 100 will be able to make the transition from the state label S₁ to the state label S₂ is 0.5. Similarly, the user location tracking device 100 can make a transition from the state label S₂ to the state label S₁ or the state label S₃. On this account, when the probability that the user location tracking device 100 will stay at the state label S₂ is 0.5, the probability that the user location device 100 will be able to make the transition from the state label S₂ to the state label S₁ is 0.25 and the probability that the user location device 100 will be able to make the transition from the state label S₂ to the state label S₃ is 0.25.

To be more specific, as shown in FIG. 11A, the transition probability a₁₂ that the user location tracking device 100 will be able to make the transition from the state label S₁ to the state label S₂ is 0.5 and, similarly, a₂₁=0.25 and a₂₃=0.25. Moreover, the transition probability a₁₁ that the user location tracking device 100 will stay at the state label S₁ is 0.5 and, similarly, a₂₂=0.5. The transition probability aᵢⱼ is calculated in this way.

Furthermore, the detection unit 101 receives radio waves of the wireless devices 10a and 10b at the state label S₁. Thus, the probability that the wireless device 10a, which is an access point here, will be detected at the state label S₁ is 1.0. Similarly, the probability that the wireless device 10b, which is an access point here, will be detected at the state label S₁ is 1.0 as well.

To be more specific, as shown in FIG. 11B, the probability b₁₁₀ₐ of detecting the wireless device 10a at the state label S₁ is 1.0 and the probability b_{110b} of detecting the wireless device 10b at the state label S₁ is 1.0. In this way, the probability bₙₘ of detecting the access point m at the state label Sₙ is calculated.

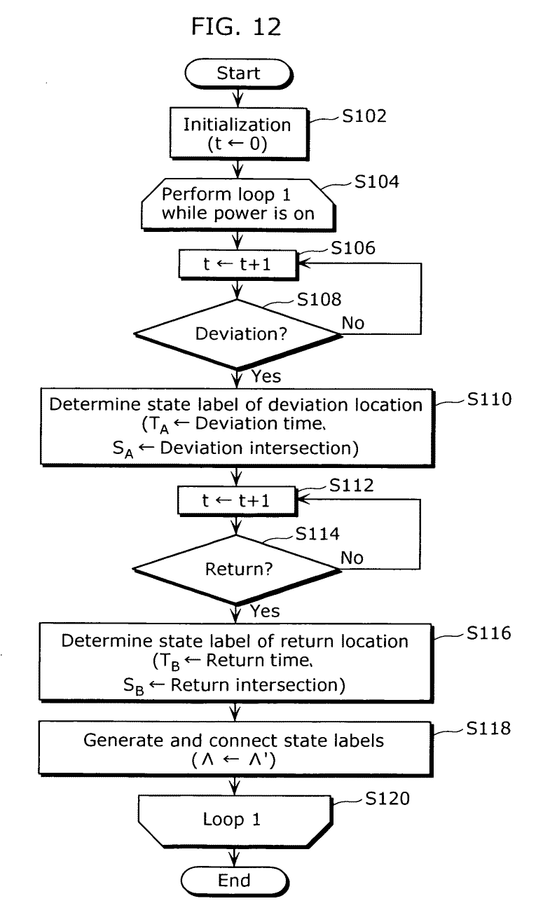

Next, an explanation is given as to a basic flow of the processing performed by the path estimation unit 103 which uses hidden Markov models. FIG. 12 is a flowchart showing the processing performed by the path estimation unit 103 which uses the hidden Markov models, according to the second embodiment.

First, when an already-generated HMM exists in a nonvolatile memory or the like, an initial model Λ={aᵢⱼ (1≦i, j≦N), bₙₘ (1≦n≦N. 1≦m≦M)} is read. When no HMMs exist in the nonvolatile memory or the like, a model Λ is generated, using o (1), as Λ={a₁₁=1, b₁ₘ=o_{m, 1}(1≦m≦M)} (step S102).

Then, while the power is on, the following processing from step S106 to step S118 is repeated as a loop 1 (step S104 to step S120).

When the time t advances by one (step S106), the deviation judgment unit 111 judges whether or not the user location tracking device 100 is deviating from the modeled path (step S108).

First, the detection unit 101 detects o (t) by detecting the access points. Then, from the probability bₙₘ and o (t) of the state label Sₙ, the deviation judgment unit 111 calculates the probability bₙ (o (t))=P (o (t)|Sₙ) that the combination o (t) will be observed at the state label Sₙ. When the current time t is 1, the deviation judgment unit 111 calculates as follows.

$$\begin{matrix}{α}_{n} ( 1 ) = P ( q ( 1 ) = {S}_{n} \vert o ( 1 ) , Λ ) \\ = \frac{{b}_{n} ( o ( 1 ) )}{{\sum }_{n = 1}^{N} {b}_{n} ( o ( 1 ) )}\end{matrix} \qquad Equation 7$$

Here, aₙ(t) refers to the probability that the user location tracking device 100 will stay at the state label Sₙ at the time t when the detection unit 101 detects o (1) to o (t). Note that, in the initial state, a₁ (1)=1. When t>1, aₙ (t) can be calculated by the following recurrence equation using aₙ (t−1) which has been already calculated.

$$\begin{matrix}{α}_{n} ( t ) = P ( q ( t ) = {S}_{n} \vert o ( 1 ) , Λ o ( t ) , Λ ) \\ = \frac{{\sum }_{i = 1}^{N} {α}_{i} ( t - 1 ) {a}_{i n} {b}_{n} ( o ( t ) )}{{\sum }_{n = 1}^{N} {\sum }_{i = 1}^{N} {α}_{i} ( t - 1 ) {a}_{i n} {b}_{n} ( o ( t ) )}\end{matrix} \qquad Equation 8$$

To be more specific, the deviation judgment unit 111 calculates the probability aₙ (t) that the user location tracking device 100 will stay at the state label Sₙ at the time t, by predicting the current location of the user location tracking device 100 using the immediately preceding aₙ (t−1) and transition constraint information aᵢₙ and then correcting this prediction value using bₙ (o (t)).

Here, this recurrence equation is called the forward algorithm, and the Viterbi algorithm may be used. Note here that although the Viterbi algorithm calculates only the maximum likelihood path instead of marginalization, similar substitution or reverse substitution is also possible in the following equations.

When it is judged that the user location tracking device 100 is not deviating from the model Λ at the time t, t′ (where t′<t) which gives the largest TC (o (t), o (t′)) is estimated to be the set {t′|q (t′)=arg maxₙaₙ (t)}. The average value of TC (o (t), o (t′)) with respect to the set is given by the following equation as a conditional expected value.

TC_{A}(t)=E[TC(o(t), o(t′))|q(t′)=arg maxₙαₙ(t)] Equation 9

Here, in order to directly calculate E [TC (o (t), o (t′))|q (t′)=Sₙ], all of o (t) need to be stored. On this account, it is approximated by the following equation using E [o (t′)|q (t′)=Sₙ]=(bₙ₁, . . . , and b_{nM}).

$$E [ TC ( o ( t ) , o ( {t}^{′} ) ) \vert q ( {t}^{′} ) = {S}_{n} ] ≅ \frac{{\sum }_{m = 1}^{M} {b}_{n m} {o}_{m , t}}{\begin{matrix}{\sum }_{m = 1}^{M} ( {b}_{n m} + {o}_{m , t} ) - \\ {\sum }_{m = 1}^{M} {b}_{n m} {o}_{m , t}\end{matrix}} \qquad Equation 10$$

To be more specific, from the probability bₙₘ and o (t) of the state label Sₙ, the deviation judgment unit 111 calculates the similarity TC_{A} (t) of the reception areas between the state label Sₙ where the probability an (t) is the largest and the location where o (t) is observed. When the value of TC_{A} (t) calculated in this way is below a certain criterion, the deviation judgment unit 111 judges that the user location tracking device 100 is deviating from the model Λ.

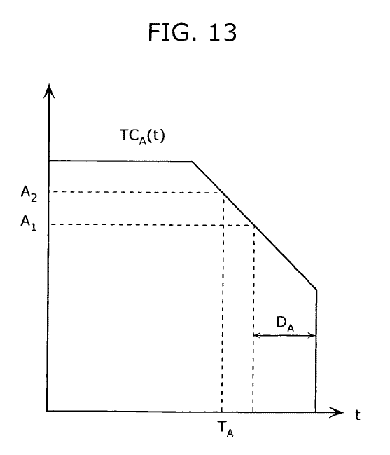

FIG. 13 is a diagram showing an example of the judgment criterion employed by the deviation judgment unit 111, according to the second embodiment.

For example, when the value has continued to be small for a fixed period of time, that is, when TC_{A} (t′)<A₁ is obtained with respect to t′, where t−D_{A}≦t′≦t, the user location tracking device 100 is estimated to have traveled along a path, which has never been traveled before, for a fixed period of time or longer. Hence, it is judged that the user location tracking device 100 is judged to have completely deviated from the model Λ. In this case, as shown in FIG. 13 for example, TC_{A} (t′), where t′<t, is checked in the backward direction from the current time t to the past so as to estimate a time immediately before the deviation, i.e., the deviation time. Then, the time which reaches a fixed value A₂ or higher for the first time, that is, t′=T_{A}, is determined as the deviation time. Here, a degree of precision in judgment can be improved further by using the number of detected access points, a time integration value of TC_{A} (t), and the like. Note that, in the residential district, it was suitable when A₁ was 0.4, A₂ was 0.6, and D_{A} was around 30 seconds.

Back to FIG. 12, when the deviation judgment unit 111 judges that the user location tracking device 100 is not deviating from the model Λ (No in step S108), the time t advances by one or the deviation judgment unit 111 waits for the detection unit 101 to finish measuring the time t+1 when online (step S106). Then, the deviation judgment processing is repeated (step S108).

On the other hand, when the deviation judgment unit 111 judges that the user location tracking device 100 is deviating from the model Λ (Yes in step S108), the deviation intersection determination unit 112 determines the state label at which the deviation occurred (step S110). To be more specific, the deviation intersection determination unit 112 determines a deviation intersection S_{A} by the following equation using the time T_{A} and aₙ (t) estimated by the deviation judgment unit 111.

S_{A}=arg maxₙαₙ(T_{A}) Equation 11

Then, the time t advances by one (step S112), the return judgment unit 113 judges whether or not the user location tracking device 100 has returned to the modeled path (step S114). The return judgment unit 113 basically applies the algorithm of the deviation judgment unit 111 in the backward direction from the current time t to the past.

To be more specific, the detection unit 101 first detects o (t) by detecting the access points. Then, the return judgment unit 113 calculates the probability bₙ (o (t))=P (o (t)|Sₙ) that the combination o (t) is observed at the state label Sₙ, from the probability bₙₘ and o (t) of the state label Sₙ. Next, from the probability bₙₘ and o (t) of the state label Sₙ, the return judgment unit 113 calculates the similarity TC_{B} (t) between the reception areas of the state label Sₙ where the probability P (o (t)|Sₙ) is the largest and the location where o (t) is observed.

More specifically, the return judgment unit 113 adapts the equation of the deviation judgment unit 111 where t=1 to the current time t, and calculates the following equations.

$$\begin{matrix}\begin{matrix}{β}_{n}^{( t )} ( t ) = P ( q ( t ) = {S}_{n} \vert o ( t ) , Λ ) \\ = \frac{{b}_{n} ( o ( t ) )}{{\sum }_{n = 1}^{N} {b}_{n} ( o ( t ) )}\end{matrix} & Equation 12 \\ {TC}_{B}^{( t )} ( t ) = E [ TC ( o ( t ) , o ( {t}^{′} ) ) \vert q ( {t}^{′} ) = arg {max}_{n} {β}_{n}^{( t )} ( t ) ] & Equation 13\end{matrix}$$

When TC_{B}^{(t)} (t) is a fixed value B₁ or larger, it is possible that the user location tracking device 100 may have returned to the path on the model Λ at the current time t. In this case, the return judgment unit 113 further calculates βₙ^{(t)} (t′) and TC_{B}^{(t)} (t′) with respect to the past time t′, where t−D_{B}≦t′<t, using the following recurrence equation.

$$\begin{matrix}{β}_{n}^{( t )} ( {t}^{′} ) = P ( q ( t ) = {S}_{n} \vert o ( {t}^{′} ) , Λ , o ( t ) , Λ ) \\ = \frac{{\sum }_{i = 1}^{N} {a}_{ni} {b}_{n} ( o ( {t}^{′} ) ) {β}_{n}^{( t )} ( {t}^{′} + 1 )}{{\sum }_{n = 1}^{N} {\sum }_{i = 1}^{N} {a}_{ni} {b}_{n} ( o ( {t}^{′} ) ) {β}_{n}^{( t )} ( {t}^{′} + 1 )}\end{matrix} \\ {TC}_{B}^{( t )} ( {t}^{′} ) = E [ \begin{matrix}TC ( o ( {t}^{′} ) , \\ o ( {t}^{″} ) ) \vert q ( {t}^{″} ) = arg {max}_{n} {β}_{n}^{( t )} ( {t}^{′} )\end{matrix} ] \qquad Equation 14$$

It should be noted that since the recurrence equation of βₙ^{(t)} (t′) is a special form of the forward-backward algorithm, the forward-backward algorithm may be used instead. When the value of TC_{B}^{(t)} (t′), where t−D_{B}≦t′<t, obtained in this way exceeds a certain criterion, the return judgment unit 113 judges that the user location tracking device 100 has returned to the model Λ.

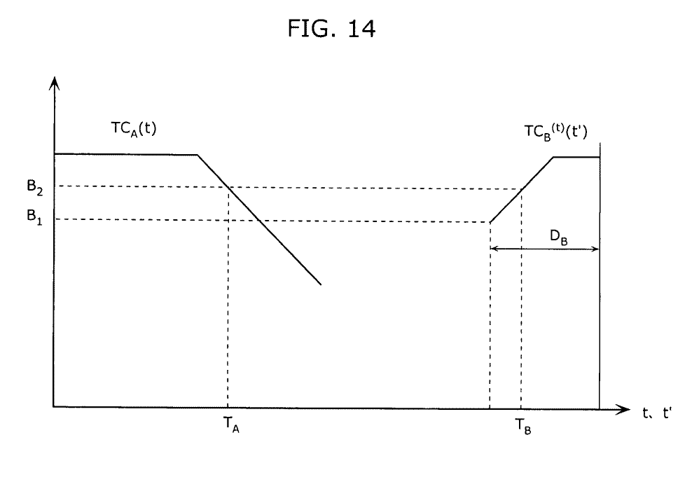

FIG. 14 is a diagram showing an example of the judgment criterion employed by the return judgment unit 113, according to the second embodiment.

For example, when the value has continued to be large for a fixed period of time, that is, when TC_{B} (t′)≧B₁ is obtained with respect to t′, where t−D_{A}≦t′≦t, the user location tracking device 100 is estimated to have traveled along the model Λ for a fixed period of time or longer. Hence, the return judgment unit 113 judges that the user location tracking device 100 has completely returned to the model Λ.

In this case, as shown in FIG. 14 for example, the return judgment unit 113 checks TC_{B} (t′), where t′<t, in the backward direction from the current time t to the past so as to estimate a time immediately after the return, i.e., the return time. Then, the time which reaches a fixed value B₂ or higher for the first time, that is, t′=T_{B}, is determined as the return time. Here, a degree of precision in judgment can be improved further by using the number of detected access points, a time integration value of TC_{B} (t′), and the like. Note that, in the residential district, it was suitable when B₁ was 0.6, B₂ was 0.6, and D_{B} was around 30 seconds.

Back to FIG. 12, when the return judgment unit 111 judges that the user location tracking device 100 has not returned to the model Λ (No in step S114), the time t advances by one or the return judgment unit 113 waits for the detection unit 101 to finish measuring the time t+1 when online (step S112). Then, the return judgment processing is repeated (step S114).

On the other hand, when the return judgment unit 113 judges that the user location tracking device 100 has returned to the model Λ (Yes in step S114), the return intersection determination unit 114 determines the state label at which the return occurred (step S116). To be more specific, the return intersection determination unit 114 determines a return intersection S_{B} by the following equation using the time T_{B} and βₙ^{(t)} (t′) estimated by the return judgment unit 113.

S_{B}=arg maxₙβₙ^{(t)}(T_{A}) Equation 15

Next, the path tracking unit 115 generates a new sequence of state labels which corresponds in length to a period of time taken from the deviation to the return, and connects this sequence to the state labels determined by the deviation intersection determination unit 112 and the return intersection determination unit 114 (step S118).

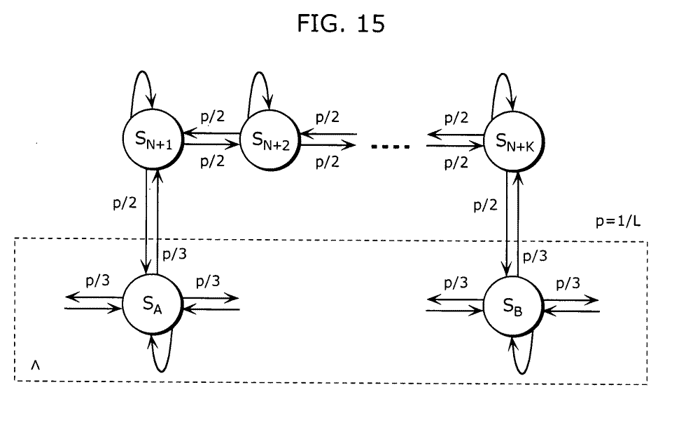

FIGS. 15, 16, and 17 are diagrams showing examples of methods used by the path tracking unit 115 to construct of an HMM, according to the second embodiment.

As show in FIG. 15, the path tracking unit 115 adds K number of state labels S_{N+1}, S_{N+2}, . . . , and S_{N+K} proportional to a period of time taken from the deviation time T_{A} to the return time T_{B}, to the model Λ. Then, the path tracking unit 115 determines the transition probability so that the added state labels connect the intersections S_{A} and S_{B} in line and, as a result, generates a model Λ′.

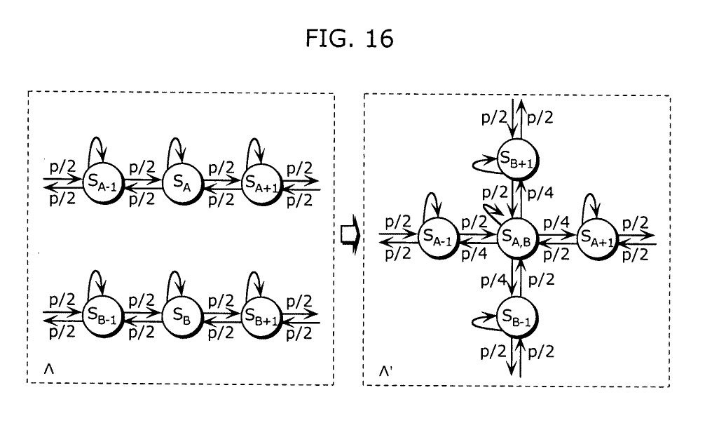

Note here that since the deviation intersection S_{A} and the return intersection S_{B} are estimated to be the same intersection when the deviation time T_{A}≧the return time T_{B}, the path tracking unit 115 combines these intersections into one state label as shown in FIG. 16. This is because, in the case where the deviation intersection S_{A} and the return intersection S_{B} are different intersections, it is understood that the user location tracking device 100 deviates and then returns, meaning that, under normal conditions, the deviation time T_{A}<the return time T_{B}.

Here, when an average period of stay L at the state labels is given as a constant, the value of K can be determined by K=int [(T_{B}−T_{A}−1)/L], where int [ ] indicates that all digits after the decimal point are truncated. In this case, the state transition takes place once per L. Hence, aₙₘ=1−(1/L) is set as the transition probability that the state makes a transition to itself, and a value obtained by equally dividing (1/L) is set as the transition probability of the other transition destinations. The observation probability is learned from o (T_{A}+1), . . . , and o (T_{B}−1). The easiest method is to determine the probability bₙₘ, where N+1≦n≦N+K, by dividing into K groups, with each group including L, and by averaging out these groups according to the following equation.

$$( {b}_{n 1} , Λ , {b}_{nM} ) = \frac{1}{L} {\sum }_{i = 1}^{L} o ( {T}_{A} + [ n - ( N + 1 ) ] \cdot L + i ) \\ ( N + 1 \leq n \leq N + K ) \qquad Equation 16$$

It should be noted that instead of equal division, the division may be made into K groups according to the segmental k proximity-based localization. Moreover, parameters generated by the equal division or the division according to the segmental k proximity-based localization may be optimized using the Baum-Welch retraining algorithm. When using the Baum-Welch retraining algorithm, the value of the transition probability does not have a great influence unless it is incorrect to an extreme and, thus, only the observation probability may be optimized. Also, when using the Baum-Welch retaining algorithm, although the amount of computation is traded off, the value of K may be determined so that the Akaike's information criterion (AIC) or the minimum description length (MDL) criterion used as an indicator of balance between complexity and error in models would be minimum. With this, the generated model can be reduced to a minimum without loss in recognition accuracy.

In the case of equal division, L=2 to 4 was suitable for the detection cycle which is 5 to 10 seconds. Here, the value of L is not necessarily an integer. However, when L is below 1.2, the state transition on the HMM may not be able to follow the actual movement due to variations in walking speed. For this reason, it is preferable to set the value of L larger than 1.2 or to set a path on which the state transition takes place every state or every few states.

In the above explanation, although one state label is assigned for each location, a plurality of state labels may be assigned for each location. More specifically, to a new sequence of state labels generated by the path tracking unit 115, a plurality of state labels may be assigned at the same location in order for each traveling direction to have a state label and these state labels at the same location may share the same observation probability.

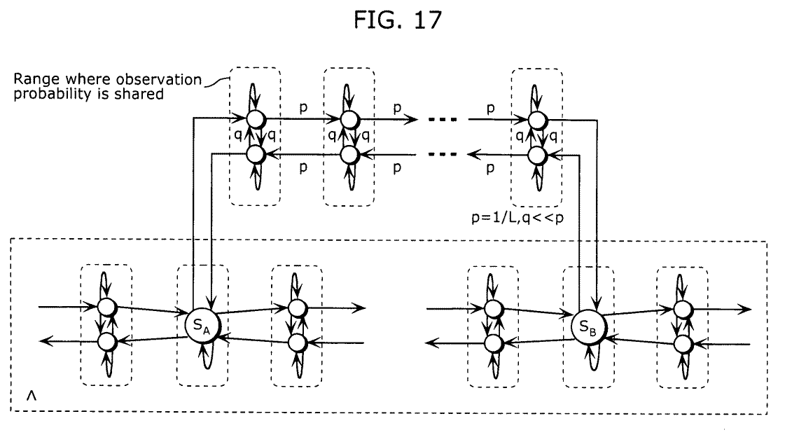

For example, as shown in FIG. 17, a state label is assigned for each traveling direction and the average period of stay L is set to be close to the actual traveling speed dispersion. As a result, the accuracy in determining intersections is improved. Note that “q” in this diagram denotes the probability of change in direction. Also note that although it is preferable and easy for the observation probability to be shared at the same location, the observation probability may be trained for each traveling direction when the receiver sensitivity of the detection unit 101 varies considerably depending on the user's orientation.

In this way, the processing performed by the path estimation unit 103 is repeated as the loop 1 from step S104 to step S120. In the repetition, a model Λ′ is used in place of the model Λ, and it is preferable for aₙ (t) and TC_{A} (t) to be recalculated at a time near the time T_{A}+1 where the deviation from the model Λ occurs.

It should be noted that when aₙ (t) is used only by the deviation judgment unit 111, aₙ (t) may be calculated from T_{B}+1 according to aₙ (T_{B})=βₙ^{(t)} (T_{B}) or may be calculated simply as aₙ (t)=βₙ^{(t)} (t), with consideration given to: that HMMs generated in the present embodiment are ergodic, meaning that, in experiments performed within the residential district, the filter distribution is converted in an approximately constant distribution when an observed sequence from about 50 seconds before is present; and that the user has returned to model Λ at the time T_{B}, and aₙ^{(t)} (t′) and aₙ (t′), where t′≦t, show the similar distributions at locations where no deviations occur.

In this way, the topology of the travel path is determined using the hidden Markov models, and the determined topology can be displayed as the travel range of the user.

### (First Modification)

In the above second embodiment, the user location tracking device 100 does not estimate its current location. On the other hand, in the present modification, the user location tracking device 100 estimates its current location using the location estimation unit 116. To be more specific, when the user location tracking device 100 is not deviating from the tracked path, the location estimation unit 116 performs maximum likelihood estimation for estimating the current location of the user location tracking device 100, using the historical data and the hidden Markov models obtained up to the current time.

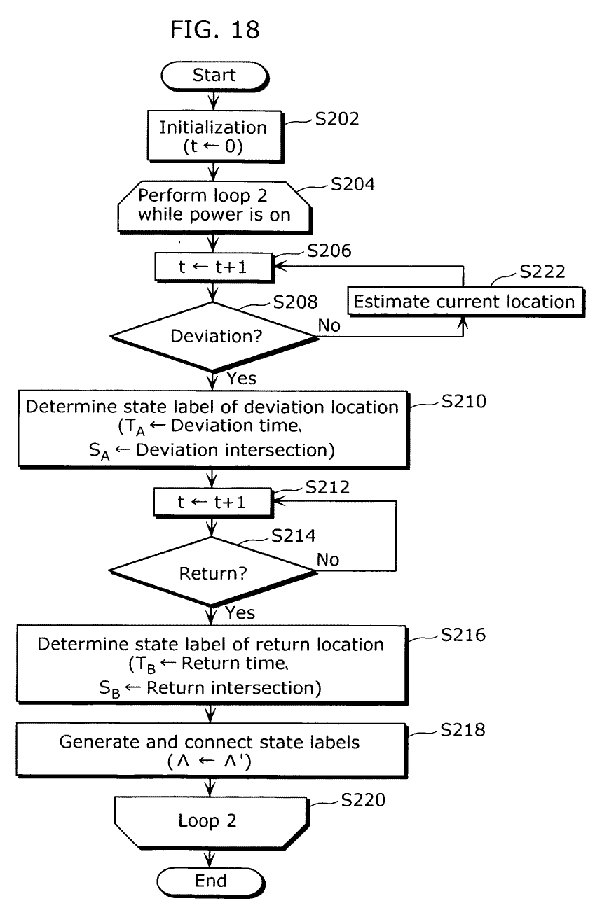

FIG. 18 is a flowchart showing processing performed by the path estimation unit 103, according to the first modification of the second embodiment. Note that an explanation regarding the same steps as in the flowchart of FIG. 12, that is, steps S202 to S206 and steps S208 to S220, is omitted here and that only a different step, i.e., step S222, is explained.

When it is judged that the user location tracking device 100 is not deviating from the model Λ (No in step S208), the location estimation unit 116 estimates the current location on the model Λ (step S222). More specifically, the maximum likelihood estimate of the location q (t) on the model Λ at the current time t is given according to the following equation using aₙ (t) calculated by the deviation judgment unit 111.

\hat{q}(t)=arg maxₙαₙ(t) Equation 17

This is to say that the location estimation unit 116 estimates the state label Sₙ, where the probability aₙ (t) is the greatest, to be the current location. Accordingly, the state label of the current location at a certain position can be stored as a focused location, and a revisit to this location may be detected.

Note that when the location at the past time t′ is to be estimated, it is preferable to use the forward-backward algorithm instead of aₙ (t).

Also, a travel period estimation unit 119 for estimating a period of time to be taken to that location may be further included. For the estimation of the travel period, the state labels until that location may be determined according to Dijkstra's algorithm or the like, and then the average periods of stay may be added up. When sharing the generated models, a distance from or a time period taken to travel to another user location tracking device 100 can be calculated.

For determining an actual physical location from the state label, for example, pattern matching with the map information is performed using the topology of the generated HMM and the distance estimated from the number of state labels on the path, and then each state label is brought into correspondence with a location on the map. Note that, in the experiments performed within the residential district, the resolution performance at identifiable locations was on the order of 15 to 40 meters.

### (Second Modification)

In order to avoid the accumulation of the environmental changes, the path estimation unit 103 may perform retraining to update the observation probability parameter bₙₘ using o (t) detected when the same path is traveled again. In other words, the path estimation unit 103 performs retraining to update the observation probability of the HMM, using the historical data obtained from the return time to the deviation time.

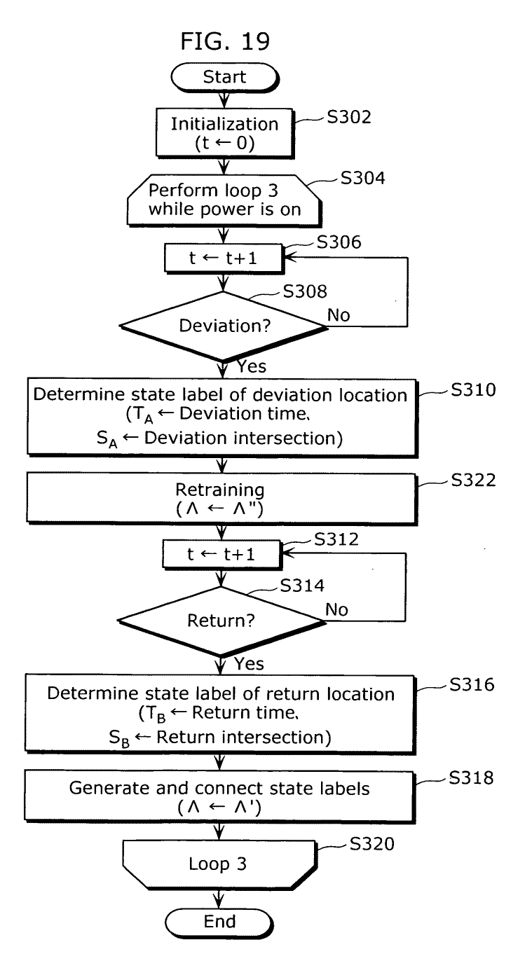

FIG. 19 is a flowchart showing processing performed by the path estimation unit 103, according to the second modification of the second embodiment. Note that an explanation regarding the same steps as in the flowchart of FIG. 12, that is, steps S302 to S310 and steps S312 to S320, is omitted here and that only a different step, that is, step S322, is explained.

After the deviation intersection determination unit 112 determines the state label of the location where the deviation occurred (step S310), the path estimation unit 103 performs updates little by little according to, for example, the following equation using aₙ (t) calculated by the deviation judgment unit 111 and a training coefficient r (step S322).

(b′ₙ₁,Λ, b′_{nM})=[1−rαₙ(t)]·(bₙ₁,Λ,b_{nM})+rαₙ·o(t) (1≦n≦N) Equation 18

Alternatively, the path estimation unit 103 may apply the Baum-Welch retraining algorithm or the like using the entire o (t) stored so as to update the observation probability parameter bₙₘ by one operation. Moreover, the path estimation unit 103 may delete the state labels of the path that have not been traveled for a fixed period of time.

### (Third Modification)

The timing of when the path tracking unit 115 adds the state labels of a new path does not necessarily need to be after the return is detected. For example, the path tracking unit 115 may add the state labels of the new path every fixed period of time after the deviation is detected or at a time when a stop is detected using an acceleration sensor or the like.

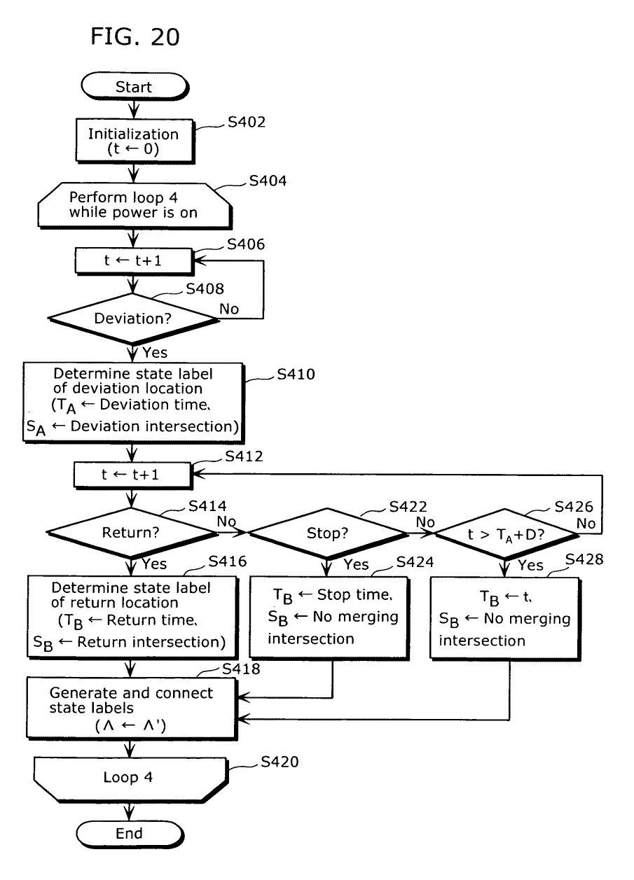

FIG. 20 is a flowchart showing processing performed by the path estimation unit 103, according to the third modification of the second embodiment. Note that an explanation regarding the same steps as in the flowchart of FIG. 12, that is, steps S402 to S412 and steps S414 to S420, is omitted here and that only different steps, that is, steps S422 to S428, are explained.

When it is judged that the user location tracking device 100 has not returned to the modeled path (No in step S414), the path tracking unit 115 judges whether or not the user location tracking device 100 is making a stop (step S422). Here, when judging that the user location tracking device 100 is making a stop (Yes in step 5422), the path tracking unit 115 judges that there is no merging intersection at the stop time T_{B} (step S424).

On the other hand, when judging that the user location tracking device is not making a stop (No in step S422), the path tracking device 115 judges whether or not a predetermined period of time has elapsed after the judgment of deviation (step 5426). Here, when the path tracking unit 115 judges that the predetermined period of time has not elapsed (No in step 5426), the time t advances by one (step S412) and the return judgment processing (step S414) is repeated.

On the other hand, when judging that the predetermined period of time has elapsed (Yes in step S426), the path tracking unit 115 judges that there is no merging intersection (step S428).

The present embodiment discloses a case where IEEE 802.11 access points are used for estimating the location of the mobile terminal. However, instead of or in addition to radio waves of the access points, radio waves sent from other wireless devices may be used.

It should be noted that, although this might be against the intuitive concept, the wireless devices which send radio waves to be used for tracking the user location in the present embodiment do not necessarily need to be fixed. Even a wireless device such as a mobile terminal can be used instead of or in addition to an access point as long as the wireless device can send a beacon signal at a specific location while being charged by a battery charger for example. This is because the parameters P_{A} and P_{B} with consideration of environmental changes are adopted and because maximum likelihood sequence estimation is performed using HMMs.

Note that when the wireless device sends the beacon signal not only at the specific location but while moving as well, the present invention can be applied when the parameter P_{A} is increased to a large value in the case where there is a statistical bias in the location of the wireless device.

In the present embodiment, a vector of a binary variable, which regards whether or not the access points are detected, i.e., the presence or absence of detection, is used as the observed variable of the HMM. However, in the case of a more precise HMM, not only a binary variable but also a continuous value can be used as the observed variable. Therefore, those skilled in the art will readily assume that the calculation result obtained based on the HMM can be refined using received signal strength indicators (RSSI) of the access points.

In most of the location detection technologies using IEEE 802.11 access points, RSSI is used in order to insure accuracy and, for this reason, it might be expected that only the combination of the presence and absence of detection is inadequate. Here, it should be pointed out that most of the technologies using the training algorithm are supervised training.

In the experiments carried out in the residential district, however, it was adequate for estimating the topology of the travel path. This is because, on the parallel roads, the radio wave environments are greatly different due to shadowing of the buildings. Moreover, near an intersection, the view is not obstructed as compared with other locations, so that a characteristic change is readily caused. Thus, the position of the deviation or return intersection that is important in determining the topology can be estimated with a high degree of accuracy.

In the refinement using RSSI, it is necessary to statistically separate the fading element and the change in the received signal strength indicator. Thus, a sufficient number of passages on the same path are needed. It is presumably suitable to first generate a model structure using only the combination of the presence and absence of detection and then to perform refinement using the Baum-Welch retraining algorithm when the historical data is collected after the sufficient number of passages on the same path.

When taken as a training problem of HMMs, the method of the present embodiment has a characteristic where the model structure and the model parameters are trained at the same time through unsupervised training.

According to the conventional HMM fingerprinting-based localization, the model structure needs to be generated in advance using a separate piece of information, such as a map or a layout sketch. Also, in the conventional model parameter training, teacher data such as the sequence of o (t) labeled with GPS coordinates, or an initial value of a model parameter used for the retraining algorithm is required.

In the present embodiment, the model structure of the HMM and the model parameter are both generated only from the sequence of o (t). It should be noted that although there is an unsupervised training algorithm, such as sequential state partition method, for the model structure in the speech recognition field, an L-to-R model which performs state transitions only in one direction is assumed. Since a travel path might be looped, it is difficult to determine the model structure from o (t) using this algorithm.

Moreover, the policy of most of the HMM training algorithms is to obtain the maximum likelihood estimate of the model Λ, that is, Λ which maximizes P (o (1), . . . , and o (T)|Λ). However, in the case of the maximum likelihood estimation, since the state labels are hardly assigned on the path where the access points and the passages are small in number, Λ obtained through the maximum likelihood estimation based on the sequence of o (t) is different from the topology of the travel path in general. Even in the case of the same topology, the state labels are assigned disproportionately. This causes undesirable properties for determining the intersections and the current location, such as that the number of state labels does not represent the length of the travel path and that a characteristic change when an intersection is traveled in a straight line is not learned.

In the present embodiment, it is not the maximum likelihood estimation that is performed because there is a limit to the model structure to be searched, that is, the structure where the state label which is an intersection is connected by paths having certain lengths. Nevertheless, the topology of the travel path can be reproduced successfully.

### Third Embodiment

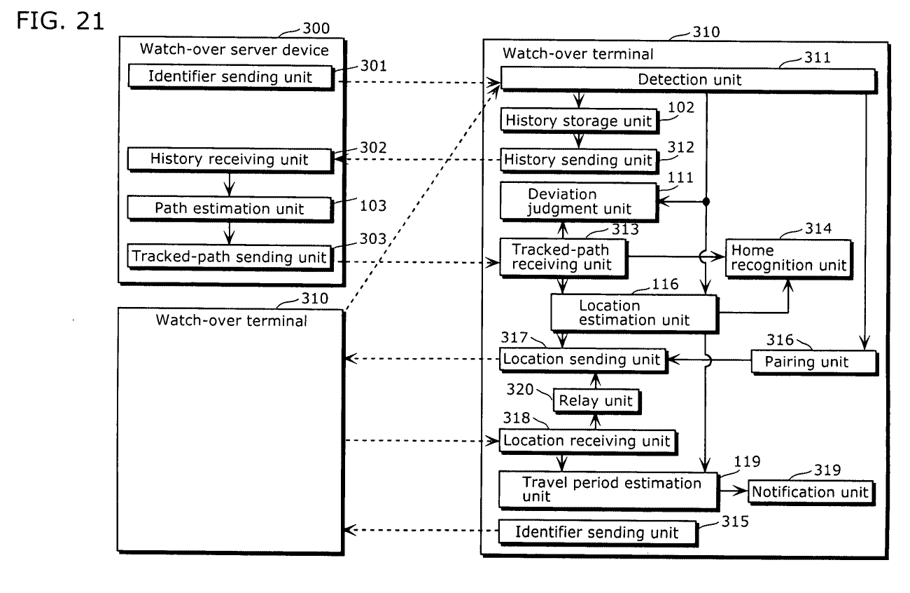

FIG. 21 is a block diagram showing a configuration of a user location tracking system, according to the third embodiment of the present invention. More specifically, FIG. 21 is a block diagram showing the system configuration where watching over children is applied on an elementary-school-wide basis using the mobility tracking method of the present invention. In this diagram, the same components as those described in the first and second embodiments are denoted by the same numerals as shown in FIGS. 1 and 3, and the explanations of these components are thus omitted.

The user location tracking system includes a watch-over server device 300 which is set up in an elementary school and watch-over terminals 310 which are respectively carried by a student attending this elementary school and a parent of the student. Short-range wireless communication between the watch-over server device 300 and the watch-over terminal 310 is carried out according to IEEE 802.11 or 802.15.4. It should be noted that the watch-over server device 300 corresponds to the “user location tracking server” described in the claims of the present specification whereas the watch-over terminal 310 corresponds to the “user location tracking device” described in the claims of the present specification.

As shown in FIG. 21, the watch-over server device 300 includes an identifier sending unit 301, a history receiving unit 302, a path estimation unit 103, and a tracked-path sending unit 303.

The identifier sending unit 301 sends a radio wave including an identifier to the watch-over terminal 310 on a regular basis. Note that since it is desirable for the radio wave from the identifier sending unit 301 to reach as far as the entire school, a plurality of identifier sending units 301 may be included.

The history receiving unit 302 receives historical data from the watch-over terminal 310. The tracked-path sending unit 303 sends a hidden Markov model generated by the path estimation unit 301 to the watch-over terminal 310. It is preferable that the history receiving unit 302 and the tracked-path sending unit 303 be set up near the school gate.

The watch-over terminal 310 includes a detection unit 311, a history storage unit 102, a history sending unit 312, a tracked-path receiving unit 313, a deviation judgment unit 111, a location estimation unit 116, a home recognition unit 314, an identifier sending unit 315, a pairing unit 316, a location sending unit 317, a location receiving unit 318, a travel period estimation unit 119, a notification unit 319, and a relay unit 320.

The history receiving unit 302 of the watch-over server device 300 receives historical data 102a sent from the history sending unit 312 of the watch-over terminal 310 on arrival at the school, the historical data 102a being obtained while the student is going mainly through a school zone. Applying the received historical data 102a in order, the path estimation unit 103 generates a hidden Markov model of the entire school zone or the like. The processing performed by the path estimation unit 103 is the same as that is performed in the second embodiment, except that the historical data 102a from a plurality of terminals is applied in order in the present embodiment. The tracked-path sending unit 303 sends the hidden Markov model generated by the path estimation unit 103 on a regular basis. The sent Markov model is received by the tracked-path receiving unit 313 of the watch-over terminal 310 when the student leaves the school, for example.

The detection unit 311 of the watch-over terminal 310 carried by the student receives identifiers respectively sent from the identifier sending unit 301 of the watch-over server device 300 and from the identifier sending unit 315 of the other watch-over terminal 310. Note that the detection unit 311 and the history storage unit 102 may record MAC addresses of ubiquitously available IEEE 802.11 access points by receiving beacon signals regularly sent from the access points.

When the student carrying the watch-over terminal 310 arrives at the school, the detection unit 311 of the watch-over terminal 310 detects the identifier of the identifier sending unit 301 included in the watch-over server device 300.

The history sending unit 312 of the watch-over terminal 310 sends the historical data 102a stored in the history storage unit 102 to the watch-over server device 300.

The tracked-path receiving unit 313 of the watch-over terminal 310 receives the hidden Markov model of the entire school zone that is generated by the path estimation unit 103 of the watch-over server device 300 on the basis of the historical data 102a. The received hidden Markov model is used by the deviation judgment unit 111 and the location estimation unit 116. Note here that since it is less often that the watch-over terminal 310 owned by the parent can directly communicate with the watch-over server device 300, the watch-over terminal 310 of the parent may receive the hidden Markov model from the watch-over terminal 310 of the student.

The home recognition unit 314 of the watch-over terminal 310 recognizes the location indicated by the state label given by the location estimation unit 116 mainly during the night, as home. This is to say, when the current location estimated by the location estimation unit 116 has been indicated by the same state label for a fixed number of hours during the night for a fixed period of time, the home recognition unit 314 recognizes the location indicated by this state label as home of the user who owns the watch-over terminal 310. In the case where the watch-over terminal 310 is rechargeable, the home recognition unit 314 may recognize that the watch-over terminal 310 is at home when the watch-over terminal 310 is on a battery charger.

The identifier sending unit 315 of the watch-over terminal 310 sends a radio wave including the identifier to the other watch-over terminal 310 on a regular basis. More specifically, each identifier sending unit 315 sends the identifier given to its corresponding watch-over terminal 310. Preferably, the identifier to be sent includes a flag area showing whether the present watch-over terminal 310 is stationary at home or is currently moving, and a different identifier is thus sent depending on the case where the watch-over terminal 310 is stationary at home or is currently moving.

The history storage unit 102 of the watch-over terminal 310 stores only the identifier of the watch-over terminal 310 which is stationary at home. Thus, the identifier sent from the terminal which is currently moving is not learned in the hidden Markov model. Whether or not the watch-over terminal 310 is stationary at home is judged by the home recognition unit 314.

The pairing unit 316 of the watch-over terminal 310 recognizes the other watch-over terminal 310 whose identifier has been detected at home for a few days and which often travels with the present watch-over terminal 310, as the terminal owned by a family member. When the battery performance of the watch-over terminal 310 is insufficient, the identifier sending unit 315 may send the identifier only when placed on the battery charger. In this case, pairing with the terminal of the family member needs to be performed manually, which may be carried out using button inputs.

The location sending unit 317 of the watch-over terminal 310 sends the current location of the watch-over terminal 310 to the other watch-over terminal 310. To be more specific, the location sending unit 317 sends the current location estimated by the location estimation unit 116 to the terminal recognized by the pairing unit 316 to be the one owned by the family member, until the time comes when the home recognition unit 314 recognizes that the present watch-over terminal 310 arrives at home after it became impossible for the detection unit 311 to detect the identifier sent from the identifier sending unit 301 of the watch-over server device 300.

From the other watch-over terminal 310, the location receiving unit 318 of the watch-over terminal 310 receives the current location of the other watch-over terminal 310. To be more specific, the location receiving unit 318 receives data sent by the location sending unit 317 of the other watch-over terminal 310.

Here, the data received by the location receiving unit 318 is not data sent to the location receiving unit 318 itself, the data is relayed by the relay unit 320. Here, path control is required for this relay, and this is known as the mobile ad hoc network (MANET) technology, which can be applied to the present system.

Note that the location sending unit 317 and the location receiving unit 318 may directly communicate with each other using a long distance communication network, such as a mobile telephone network, PHS, or WiMax.

The travel period estimation unit 119 of the watch-over terminal 310 stores a focused location on the tracked path, and estimates a travel period taken from the current location of the watch-over terminal 310 to the present focused location according to Dijkstra's algorithm. Also, the travel period estimation unit 119 estimates a travel period taken from the current location of the watch-over terminal 310 to the current location of the other watch-over terminal 310, according to Dijkstra's algorithm. Here, the focused location may be arbitrary, and may be the location of the school or the location of home, for example.

When arriving at the focused location, the notification unit 319 of the watch-over terminal 310 notifies that the watch-over terminal 310 has arrived at the focused location. Also, when the travel period falls within a fixed period, the notification unit 319 notifies of this. The notification unit 319 notifies of the travel period or, when the travel period falls within the fixed period, notifies of this travel period. Moreover, when the watch-over terminal 310 deviated from the tracked path, the notification unit 319 notifies of the deviation.

For example, when the data received by the location receiving unit 318 is the data sent to the location receiving unit 318 itself, the travel period estimation unit 119 calculates a distance from the current location of its own or calculates a distance between the current location of its own and the home location recognized by the home recognition unit 314. Then, the notification unit 319 notifies the user of the calculation result. As described above, the notification unit 319 notifies of the current location until arriving at home after leaving the school. The notification may be provided only when the identifiers detected by the detection unit 311 does not include the identifier of the watch-over terminal 310 currently traveling, that is, only when the user becomes alone. Moreover, the notification unit 319 may detect when the watch-over terminal 310 is deviating from the usual school zone, and may notify of the deviation.

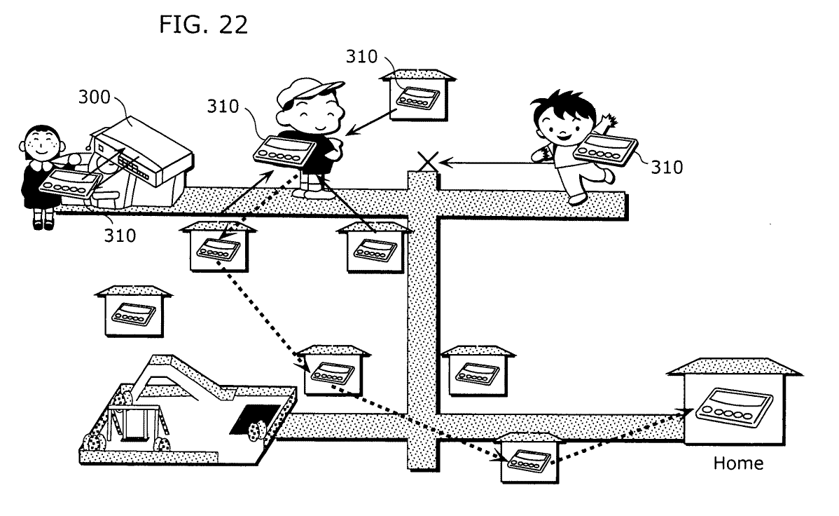

FIG. 22 is a diagram explaining the user location tracking system, according to the third embodiment of the present invention.

As shown, the watch-over server device 300 is set up in the elementary school and the watch-over terminals 310 are respectively carried by a student attending the elementary school and a parent of the student. The student carrying the watch-over terminal 310 travels between home and the school, for example. In this case, the parent can track the activities of the student carrying the watch-over terminal 310, using the other watch-over terminal 310 carried at home.

For example, when the student carrying the watch-over terminal 310 arrives at the school or will arrive at home soon, the notification unit 319 of the watch-over terminal 310 owned by the parent notifies the parent of this accordingly. Moreover, when the detection unit 311 of the watch-over terminal 310 owned by the parent cannot detect the identifier of the watch-over terminal 310 owned by the student who is currently traveling or when the travel path taken by the student is deviating from the usual school zone, the notification unit 319 of the watch-over terminal 310 owned by the parent notifies the parent of this accordingly.

According to the third embodiment as described so far, only by the watch-over server device 300 set up in the school and the watch-over terminals respectively owned by the student attending the school and by the parent of the student, the parent can be notified that the student has left the school or notified of how long it is going to be before the student comes home.

The method and the device related to the present invention have been explained on the basis of the first to third embodiments so far. However, the present invention is not limited to these embodiments. Modifications of the above embodiments and different embodiments realized by arbitrarily combining the components described in the above first to third embodiments should be included in the present invention.

For example, in the above embodiments, the wireless device information detected by the detection unit 101 shows the combination of the identifiers included in the radio waves received by the detection unit 101. However, the wireless device information detected by the detection unit 101 is not necessarily the identifiers, and may be the intensities of the received radio waves, for example. In other words, on the basis of the intensities of the received radio waves, the detection unit 101 may detect which of the ubiquitously available wireless devices 10 have sent the received radio waves.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The mobility tracking method of the present invention is useful for tracking the travel range of the user and for obtaining a location context. The present method can also be applied to the purposes, such as when a parent tracks the travel range of his or her child.

What is claimed is:

1. A mobility tracking method used by a device which tracks a travel range of a tracking object using radio waves sent from wireless devices which are ubiquitously available, said mobility tracking method comprising:
detecting wireless device information identifying wireless devices out of the ubiquitously available wireless devices when the radio waves are received at a location where the tracking object is situated;
storing the wireless device information detected in said detecting as historical data; and
estimating a topology which shows a positional relation and a connection relation of a travel path taken by the tracking object, from the historical data stored in said storing,
wherein, in said estimating of the topology, the topology is estimated as the tracking object is moving, on the basis that the location of the tracking object has deviated from a previously tracked path which has been traveled before by the tracking object and that the location of the tracking object has returned to the previously tracked path.

2. The mobility tracking method according to claim 1,
wherein said estimating of the topology includes:
judging whether or not a current location of the tracking object is deviating from the previously tracked path and, when it is judged that the current location of the tracking object is deviating from the previously tracked path, determining a time immediately before the deviation as a deviation time;
determining a location of the tracking object on the previously tracked path at the deviation time as a deviation intersection;
judging whether or not the current location of the tracking object has returned to the previously tracked path when it is judged that the current location of the tracking object is deviating from the previously tracked path and, when it is judged that the current location of the tracking object has returned to the previously tracked path, determining a time immediately after the return as a return time;
determining a location of the tracking object on the previously tracked path at the return time as a return intersection; and
determining a path taken by the tracking object from the deviation time to one of the return time and a current time as a newly tracked path, with a starting point of the newly tracked path being determined as the deviation intersection, and an ending point of the newly tracked path being determined as the return intersection when the return intersection has already been determined.

3. The mobility tracking method according to claim 2,
wherein in said estimating of the topology,
a triangular matrix is generated by calculating a degree of similarity, as an element of the triangular matrix, in the wireless device information stored in said storing between two detection cycles t and t′, where t′<t, t′being a row value and t being a column value,
a slope line area is extracted from the generated triangular matrix, the slope line area being formed by connecting adjacent elements whose degree of similarity exceeds a predetermined threshold value, and
it is judged that the tracking object is traveling along the previously tracked path in the detection cycle t where the extracted area exists.

4. The mobility tracking method according to claim 3, further comprising
estimating a location of the tracking object in the detection cycle t from an arrangement of the sloped line areas in the detection cycle t of the triangular matrix, when it is judged in said estimating of the topology that the tracking object is traveling along the previously tracked path in the detection cycle t.

5. The mobility tracking method according to claim 3,
wherein the degree of similarity calculated in said estimating of the topology is one of a Tanimoto coefficient and an expected value of the Tanimoto coefficient.

6. The mobility tracking method according to claim 2,
wherein the previously tracked path is held as a hidden Markov model in which the location of the tracking object is a state variable and the wireless device information detected in said detecting is an observed variable,
in said judging of the deviation, an observation probability is estimated for each time of day based on the historical data and the hidden Markov model of the previously tracked path obtained up to the current time, and the deviation time is determined from a degree of similarity between the estimated value of the observation probability at the time of day and the wireless device information detected at the time of day,
in said determining of the deviation intersection, a maximum likelihood estimate of the state variable at the deviation time is determined as a value of the state variable at the deviation intersection, from the historical data and the hidden Markov model of the previously tracked path obtained up to the deviation time,
in said judging of the return, an observation probability is estimated for each time of day in a backward direction from the current time to a past, based on the historical data and the hidden Markov model of the previously tracked path, and the return time is determined from a degree of similarity between: the estimated value of the observation probability at the time of day that is estimated in the backward direction from the current time to the past; and the wireless device information detected at the time of day,
in said determining of the return intersection, a maximum likelihood estimate of the state variable at the return time is determined as a value of the state variable at the return intersection, from the historical data and the hidden Markov model of the previously tracked path obtained between the return time and the current time, and
in said determining of the path: a state-label sequence of the hidden Markov model is generated as the newly tracked path; an observation probability of the newly generated state-label sequence is learned using the historical data obtained from the deviation time to one of the return time and the current time; the starting point of the newly generated state-label sequence is connected to the deviation intersection; and the ending point of the newly generated state-label sequence is connected to the return intersection when the return intersection has already been determined.

7. The mobility tracking method according to claim 6,
wherein the observation probability of the hidden Markov model is smoothed out by probabilities that the wireless devices are newly set up or relocated and that a failure occurs to the wireless devices.

8. The mobility tracking method according to claim 6,
wherein said estimating of the topology further includes
retraining to update the observation probability of the hidden Markov model using the historical data obtained from the return time to the deviation time.

9. The mobility tracking method according to claim 6,
wherein said estimating of the topology further includes
estimating the current location of the tracking object through maximum likelihood estimation using the historical data and the hidden Markov model obtained up to the current time, when the current location of the tracking object is not deviating from the previously tracked path.

10. The mobility tracking method according to claim 9,
wherein said estimating of the topology further includes
recognizing, when the current location estimated in said estimating of the current location has been indicated by a same state label for a fixed number of hours during a night for a fixed period of time, a location indicated by the state label as a home of a user who owns the tracking object.

11. The mobility tracking method according to claim 6,
wherein said estimating of the topology further includes
calculating a shortest period of time taken to travel between two state labels of the hidden Markov model, according to Dijkstra's algorithm.

12. The mobility tracking method according to claim 6,
wherein, to the state-label sequence newly generated in said determining of the path, a plurality of state labels are assigned at a same location in order for each travel direction to have one state label, and the plurality of state labels at the same location share the observation probability.

13. The mobility tracking method according to claim 1,
wherein the wireless device information detected in said detecting is a combination of identifiers included in the radio waves received in a fixed detection cycle.

14. The mobility tracking method according to claim 13,
wherein the ubiquitously available wireless devices are IEEE 802.11 access points, and the radio waves received in said detecting are beacon signals sent from the access points, and
the identifiers included in the received radio waves are IEEE 802.11 MAC addresses.

15. The mobility tracking method according to claim 1, further comprising:
estimating a current location of the tracking object on the previously tracked path, through maximum likelihood estimation;
storing a focused location on the previously tracked path;
estimating a travel period taken from the current location to the focused location according to Dijkstra's algorithm; and
notifying one of: that the current location has reached the focused location when the current location has reached the focused location; and that the travel period has fallen within a fixed period when the travel period has fallen within the fixed period.

16. The mobility tracking method according to claim 1, further comprising:
estimating a current location of the tracking object on the previously tracked path, through maximum likelihood estimation;
sending the current location of the tracking object to a separate device which tracks a travel range of a different tracking object;
receiving a current location of the different tracking object from the separate device;
estimating a travel period taken from the current location of the tracking object to the current location of the different tracking object according to Dijkstra's algorithm; and
notifying one of: the travel period; and the travel period when the travel period has fallen within a fixed period.

17. A user location tracking device for tracking a travel range of said user location tracking device using radio waves sent from wireless devices which are ubiquitously available, said user location tracking device comprising:
a detection unit configured to detect wireless device information identifying wireless devices out of the ubiquitously available wireless devices when the radio waves are received;
a storage unit configured to store the wireless device information detected by said detection unit, as historical data; and
a topology estimation unit configured to estimate a topology which shows a positional relation and a connection relation of a travel path taken by said user location tracking device, from the historical data stored in said storage unit,
wherein said topology estimation unit is configured to estimate the topology as said user location tracking device is moving, on the basis that the location of said user location tracking device has deviated from a previously tracked path which has been traveled before by said user location tracking device and that the location of said user location tracking device has returned to the previously tracked path.

18. The user location tracking device according to claim 17, further comprising
an identifier sending unit configured to regularly send a radio wave including an identifier,
wherein said identifier sending unit is configured to send the radio wave to a separate user location tracking device, only when said user location tracking device is placed on a battery charger.

19. The user location tracking device according to claim 17, further comprising
a display unit configured to map the topology estimated by said topology estimation unit and to display the mapped topology.

20. The user location tracking device according to claim 17, further comprising:
a deviation judgment unit configured to judge whether or not a current location of said user location tracking device is deviating from the previously tracked path; and
a notification unit configured, when it is judged that the current location of said user location tracking device is deviating from the previously tracked path, to notify of the deviation.

21. A user location tracking system in which a travel range of a tracking object is tracked using radio waves sent from wireless devices which are ubiquitously available, said user location tracking system comprising:
a user location tracking device which is the tracking object; and
a user location tracking server,
wherein said user location tracking device includes:
a detection unit configured to detect wireless device information identifying wireless devices out of the ubiquitously available wireless devices when the radio waves are received;
a storage unit configured to store the wireless device information detected by said detection unit, as historical data;
a history sending unit configured to send the historical data to said user location tracking server; and
a tracked-path receiving unit configured to receive a hidden Markov model from said user location tracking server, and
said user location tracking server includes:
a history receiving unit configured to receive the historical data from said user location tracking device;
a path estimation unit configured to generate the hidden Markov model of a travel path taken by said user location tracking device, using the historical data received by said history receiving unit; and
a tracked-path sending unit configured to send the hidden Markov model generated by said path estimation unit to said user location tracking device.
